(19) United States
(12) Patent Application Publication
(10) Pub. No.: US 2021/0106009 A1
(43) Pub. Date: Apr. 15, 2021

(54) AGRICULTURAL MICROBIAL COATING

(71) Applicant: Bao Q. Tran, Saratoga, CA (US)

(72) Inventor: Bao Q. Tran, Saratoga, CA (US)

(21) Appl. No.: 16/600,489

(22) Filed: Oct. 12, 2019

(51) Int. Cl. A01N 63/00; A01N 25/34; C05F 11/08

(52) U.S. Cl. CPC A01N 63/00; C05F 11/08; A01N 25/34

(57) ABSTRACT

A method for making a coating material by selecting a microbial mixture with a predetermined microbial population characteristics for predetermined plant growth property; using genetic testing to verify the presence of the microbial population characteristics and iteratively growing the mixture with the predetermined microbial population characteristics in a feedback loop; and combining the microbial mixture with a cross-linked hydrophilic mixture.

### FIELD OF THE INVENTION

The present invention relates generally to coated fertilizer/seed and methods of preparation thereof.

### BACKGROUND TO THE INVENTION

A fertilizer is any material of natural or synthetic origin (other than liming materials) that is applied to soil or to plant tissues to supply one or more plant nutrients essential to the growth of plants. Many sources of fertilizer exist, both natural and industrially produced.

Fertilizers enhance the growth of plants by being additives that provide nutrients and increasing the effectiveness of the soil by modifying its water retention and aeration. Fertilizers typically provide, in varying proportions three main macronutrients: Nitrogen (N): leaf growth, Phosphorus (P): Development of roots, flowers, seeds, fruit; Potassium (K): Strong stem growth, movement of water in plants, promotion of flowering and fruiting. Fertilizers can include three secondary macronutrients: calcium (Ca), magnesium (Mg), and sulfur (S); micronutrients: copper (Cu), iron (Fe), manganese (Mn), molybdenum (Mo), zinc (Zn), boron (B). Of occasional significance are silicon (Si), cobalt (Co), and vanadium (V). The macro-nutrients are consumed in larger quantities and are present in plant tissue in quantities from 0.15% to 6.0% on a dry matter (DM) (0% moisture) basis.

Plants are made up of four main elements: hydrogen, oxygen, carbon, and nitrogen. Carbon, hydrogen and oxygen are widely available as water and carbon dioxide. Although nitrogen makes up most of the atmosphere, it is in a form that is unavailable to plants. Nitrogen is the most important fertilizer since nitrogen is present in proteins, DNA and other components (e.g., chlorophyll). To be nutritious to plants, nitrogen must be made available in a “fixed” form. Only some bacteria and their host plants (notably legumes) can fix atmospheric nitrogen (N2) by converting it to ammonia. Phosphate is required for the production of DNA and ATP, the main energy carrier in cells, as well as certain lipids.

In a parallel trend, seed is commonly coated when growers need a precision-sown crop and the non-coated (“raw”) seed is too small, light or variable in size or shape to be sown accurately with existing equipment.

### SUMMARY OF THE INVENTION

In one aspect, a method for growing plant includes selecting a microbial mixture with a predetermined microbial population characteristics for predetermined plant growth property; using genetic testing to verify the presence of the microbial population characteristics and iteratively growing the mixture with the predetermined microbial population characteristics in a closed feedback loop; combining the microbial mixture with a cross-linked hydrophilic mixture; and coating one or more seeds with the combined microbial mixture and cross-linked hydrophilic mixture.

In another aspect, a method of coating seed includes providing a suitable plant seed; breeding a beneficial microbial mixture for predetermined microbial population guided by genetic testing of the mixture until a predetermined concentration of the microbial mixture is reached; preparing a cross-linked hydrophilic polymer solution or mixture and adding beneficial microbes and/or active ingredients to the polymer solution or mixture; coating the seed with a suitable or desired thickness of the cross-linked hydrophilic polymer solution or mixture with microbes/active ingredients; and drying the coated seed to a suitable or desired moisture content of the cross-linked hydrophilic polymer coating with microbes/active ingredients.

In a further aspect, a method of coating seed includes: providing a suitable plant seed; preparing a suitable adhesive solution; breeding a beneficial microbial mixture for predetermined microbial population guided by genetic testing of the mixture until a predetermined concentration of the microbial mixture is reached; preparing a suitable cross-linked hydrophilic polymer powder or inactive inert powder mixture; and coating the seed with a desired thickness or amount of the cross-linked hydrophilic polymer powder or mixture and adhesive solution with microbes/active ingredients.

Implementations can include one or more of the following. The coating can be a carrier. Fungicides and beneficial microbials that protect the seed and emerging seedling are carried in the coating. For example, alfalfa seed coating with incorporated rhizobacteria is used to inoculate the field with beneficial microbial.

Advantages of the system may include one or more of the following. The seed coatings prevent desiccation and provide protection from fungus, insects and enhance nutrient availability. With microbes embedded therein, the seed coatings aid improved germination characteristics for plants, and in particular for high value crop plants which may be used for transplant planting in commercial farm production, for example. The hydrogel seed treatment can store significant amounts of water and enabling microbial production once planted and watered, which in turn aids seed germination performance, such as for improving seed performance in low moisture environments. The method for coating seeds with active ingredients enhances uptake of active ingredients in resulting plants; the provision of such method that provides a relatively abrasion-resistant coating; the provision of such method that avoids the problems associated with moistening the seeds. The method improves delivery of an active ingredient to a target site or pest within or in the vicinity of the plant and the provision of a pre-emergent method for treating plants with such advantages. Seeds coated with a dry mixture of hydrogel and an active ingredient for producing a desirable effect on the seed, a plant that may emerge from the seed, or both, resists loss of coating due to abrasion encountered during handling, storage, transportation, distribution and sowing, and also provides long lasting treatment of the seed with that effect and even, if so desired, provides such treatment to the plant that later emerges from the seed The seed coating has been found to increase the uptake of the active ingredient in the resulting plant, permitting use of lower dosages of active ingredients, and to maintain an effective concentration of the active ingredient throughout the period from planting to germination, which can last a week or two, and even through the life of the later emerging plant or at least until harvesting, which can extend another several weeks or more. The seed coating can inhibit the bonding of active ingredients to the growing medium (e.g., soil) or a component thereof that has plagued conventional treatment techniques. These improvements in uptake and duration of efficacy may also be at least due in part to an interaction between the hydrogel and the active ingredient where the movement of the active ingredient is increased in an aqueous phase, thereby resulting in greater uptake of the active material into the plant via the seed or root. Thus, a single pre-planting seed treatment of this invention can provide long-term treatment of the seed, as well as post-emergent treatment of the plant, without the need for re-treatment, even in situ re-treatment, such as expensive and cumbersome treatment of crops in the field, and results in savings of the efforts, costs and drawbacks of such re-treatment, including those associated with the equipment for the re-treatment (particularly the elaborate equipment that can be required for re-treatment in the field), the re-treatment processes themselves, and the wasteful excess of active ingredient resulting from run-off, evaporation, imprecise application, and so forth. Avoiding the wasteful excess of active ingredient also reduces the risk of potential environmental problems arising from run-off of the excess active ingredient. Moreover, the dry seed coatings of the present invention further provide several advantages over the wet coatings reported in the prior art. For example, the coating is so thin and light as to avoid significant transportation, handling and storage difficulties and costs, as well as to avoid the need for new or customized equipment to handle larger seed units. Moreover, the seeds bearing the dry coatings of this invention do not require further treatments to encase the coating, as has been the case with gelatinous water-saturated hydrogel coatings described in the prior art. In addition, the dry coatings of the present invention avoid the spoilage and premature germination problems associated with use of high water contents. Such coated seed can be used in precision sowing or when growers need singulation, e.g., for cell-tray plant production in a greenhouse or strict control of spacing or depth of placement (e.g. onion spacing is critical to achieve desired bulb size at harvest) Singulation and controlled spacing are also vital for crops that are direct sown and then thinned back to the desired population. The field thinning operation is faster, cheaper and more accurate when coated seeds are used. The coated seed in a form that is larger, rounder, smoother, heavier and more uniform than the original seed. The coated seed can then be sown with a belt, plate, cup, vacuum or other type of seed. The coated seed or “pills” can be placed individually, with improved spacing and depth control. The pills also flow better through the seeding mechanism, because their surface is smoother than that of non coated seed. The coated seed can aid the transplanting of seedling plants.

### BRIEF DESCRIPTION OF THE DRAWINGS

FIG. 1-3 show exemplary processes for treating seeds.

FIGS. 4-9 show exemplary fertilizer coating processes.

FIG. 10 shows an exemplary genetic guided microbial production system running in a closed loop.

FIG. 11 shows exemplary learning machines to identify microorganisms in the microbiome.

### DETAILED DESCRIPTION OF THE PREFERRED EMBODIMENTS

The terms microbiome, microbiome information, microbiome data, microbiome population, microbiome panel and similar terms are used in the broadest possible sense, unless expressly stated otherwise, and would include: a census of currently present microorganisms, both living and nonliving, which may have been present months, years, millennia or longer; a census of components of the microbiome other that bacteria and archea, e.g. viruses and microbial eukaryotes; population studies and characterizations of microorganisms, genetic material, and biologic material; a census of any detectable biological material; and information that is derived or ascertained from genetic material, biomolecular makeup, fragments of genetic material, DNA, RNA, protein, carbohydrate, metabolite profile, fragment of biological materials and combinations and variations of these.

As used herein, the terms real-time microbiome data or information includes microbiome information that is collected or obtained at a particular setting during the fermentation process, for example soil, plant/fruit samples taken during a planting or harvesting, must, sampling of wine during alcoholic fermentation (beginning, middle and end, or depending on parameters such as alcoholic graduation, amount of sugar, density), sampling during malolactic fermentation (beginning, middle and end, or depending on amount of malic and acetic acid), barrel (beginning, middle and end, or months) and bottling.

As used herein, the terms derived microbiome information and derived microbiome data are to be given their broadest possible meaning, unless specified otherwise, and includes any real-time, microbiome information that has been computationally linked or used to create a relationship such as for example evaluating the microbiome of milk before, during, and after fermentation, or evaluating the microbiome between planting and harvesting of grapes. Thus, derived microbiome information provides information about the fermentation process setting or activity that may not be readily ascertained from non-derived information.

As used herein, the terms predictive microbiome information and predictive microbiome data are to be given their broadest possible meaning, unless specified otherwise, and includes information that is based upon combinations and computational links or processing of historic, predictive, real-time, and derived microbiome information, data, and combinations, variations and derivatives of these, which information predicts, forecasts, directs, or anticipates a future occurrence, event, state, or condition in the industrial setting, or allows interpretation of a current or past occurrence. Thus, by way of example, predictive microbiome information would include: a determination and comparison of real-time microbiome information and the derived microbiome information of quality of wine, i.e. abundance of a specific microorganism in a sample and possible positive or negative effect on the fermentation process; a comparison of real-time microbiome information collected during the fermentation of cheese and the quality of cheese.

Real time, derived, and predicted data can be collected and stored, and thus, become historic data for ongoing or future decision-making for a process, setting, or application.

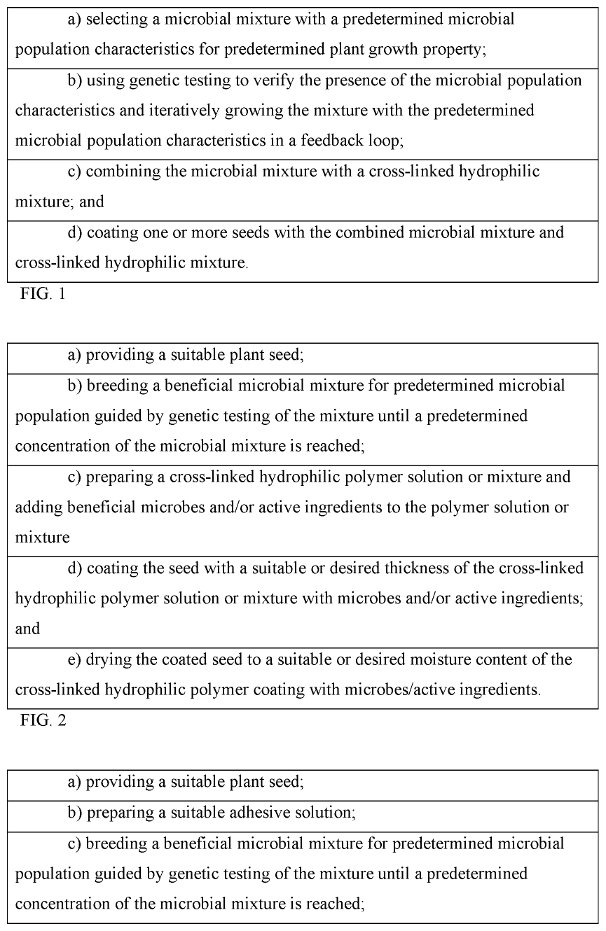

As shown in FIG. 1, a method of coating seed includes:
a) selecting a microbial mixture with a predetermined microbial population characteristics for predetermined plant growth property;
b) using genetic testing to test the microbial population characteristics and iteratively growing the mixture to reach the predetermined microbial population characteristics in a feedback loop;
c) combining the microbial mixture with a cross-linked hydrophilic mixture; and
d) coating one or more seeds with the combined microbial mixture and cross-linked hydrophilic mixture.

According to another embodiment shown in FIG. 2, a method of coating seed includes:
a) providing a suitable plant seed;
b) breeding a beneficial microbial mixture for predetermined microbial population guided by genetic testing of the mixture until a predetermined concentration of the microbial mixture is reached;
c) preparing a cross-linked hydrophilic polymer solution or mixture and adding beneficial microbes and/or active ingredients to the polymer solution or mixture
d) coating the seed with a suitable or desired thickness of the cross-linked hydrophilic polymer solution or mixture with microbes/active ingredients; and
e) drying the coated seed to a suitable or desired moisture content of the cross-linked hydrophilic polymer coating with microbes/active ingredients.

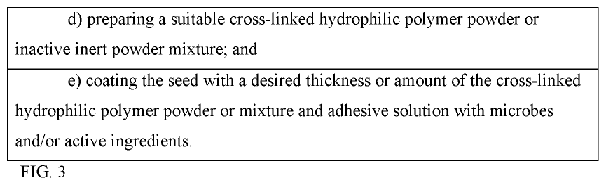

In a further embodiment shown in FIG. 3, a method of coating seed includes:
a) providing a suitable plant seed;
b) preparing a suitable adhesive solution;
c) breeding a beneficial microbial mixture for predetermined microbial population guided by genetic testing of the mixture until a predetermined concentration of the microbial mixture is reached;
d) preparing a suitable cross-linked hydrophilic polymer powder or inactive inert powder mixture; and
e) coating the seed with a desired thickness or amount of the cross-linked hydrophilic polymer powder or mixture and adhesive solution with microbes/active ingredients.

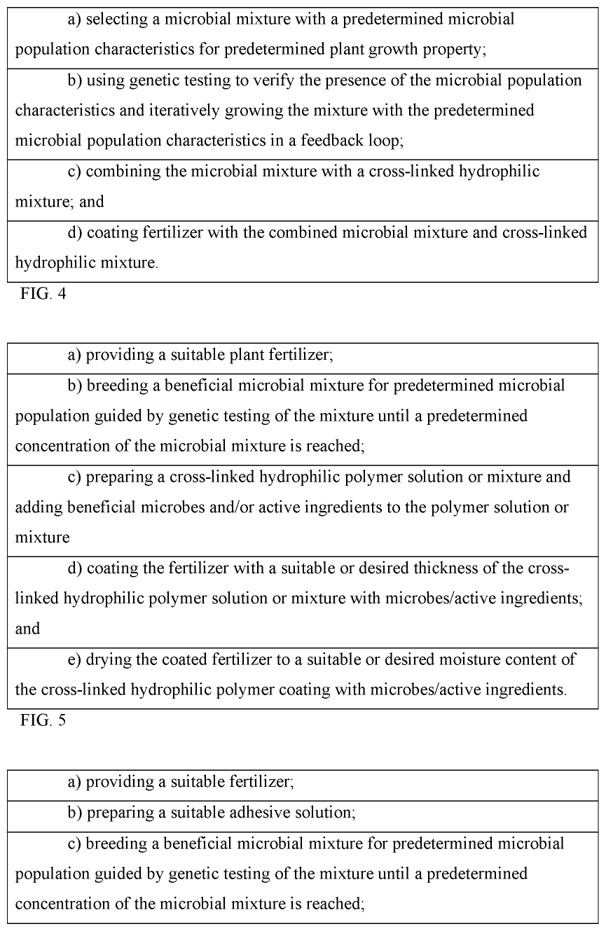

FIG. 4 shows a process with hydrogel, microbes and fertilizer that includes:
a) selecting a microbial mixture with a predetermined microbial population characteristics for predetermined plant growth property;
b) using genetic testing to verify the presence of the microbial population characteristics and iteratively growing the mixture with the predetermined microbial population characteristics in a feedback loop;
c) combining the microbial mixture with a cross-linked hydrophilic mixture; and
d) coating fertilizer with the combined microbial mixture and cross-linked hydrophilic mixture.

FIG. 5 shows a process with hydrogel, microbes and/or active ingredients, and fertilizer that includes:
a) providing a suitable plant fertilizer;
b) breeding a beneficial microbial mixture for predetermined microbial population guided by genetic testing of the mixture until a predetermined concentration of the microbial mixture is reached;
c) preparing a cross-linked hydrophilic polymer solution or mixture and adding beneficial microbes and/or active ingredients to the polymer solution or mixture
d) coating the fertilizer with a suitable or desired thickness of the cross-linked hydrophilic polymer solution or mixture with microbes/active ingredients; and
e) drying the coated fertilizer to a suitable or desired moisture content of the cross-linked hydrophilic polymer coating with microbes/active ingredients.

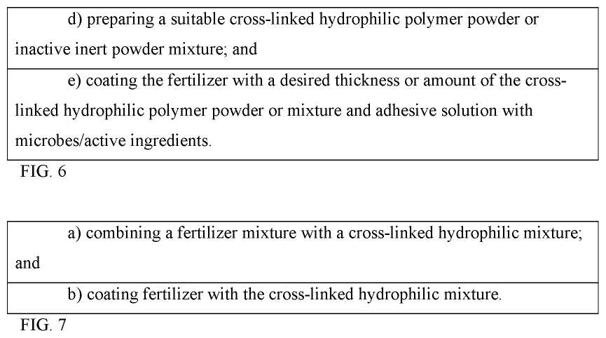

FIG. 6 shows a process with hydrogel, microbes and/or active ingredients, and fertilizer that includes:
a) providing a suitable fertilizer;
b) preparing a suitable adhesive solution;
c) breeding a beneficial microbial mixture for predetermined microbial population guided by genetic testing of the mixture until a predetermined concentration of the microbial mixture is reached;
d) preparing a suitable cross-linked hydrophilic polymer powder or inactive inert powder mixture; and
e) coating the fertilizer with a desired thickness or amount of the cross-linked hydrophilic polymer powder or mixture and adhesive solution with microbes/active ingredients.

FIG. 7 shows a process with hydrogel and fertilizer that includes:
a) combining a fertilizer mixture with a cross-linked hydrophilic mixture; and
b) coating fertilizer with the cross-linked hydrophilic mixture.

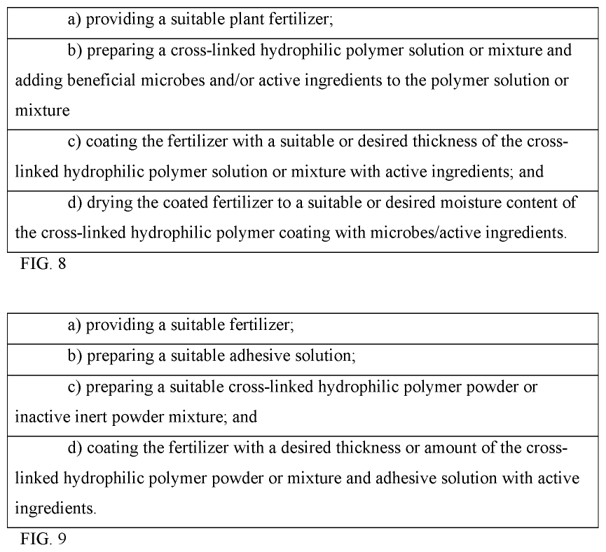

FIG. 8 shows a process with hydrogel, microbes/active materials, and fertilizer that includes:
a) providing a suitable plant fertilizer;
b) preparing a cross-linked hydrophilic polymer solution or mixture and adding beneficial microbes and/or active ingredients to the polymer solution or mixture
c) coating the fertilizer with a suitable or desired thickness of the cross-linked hydrophilic polymer solution or mixture with active ingredients; and
d) drying the coated fertilizer to a suitable or desired moisture content of the cross-linked hydrophilic polymer coating with microbes/active ingredients.

FIG. 9 shows a process with hydrogel, microbes and/or active ingredient, and fertilizer that includes:
a) providing a suitable fertilizer;
b) preparing a suitable adhesive solution;
c) preparing a suitable cross-linked hydrophilic polymer powder or inactive inert powder mixture; and
d) coating the fertilizer with a desired thickness or amount of the cross-linked hydrophilic polymer powder or mixture and adhesive solution with active ingredients.

In one embodiment, the gels have time release ingredients so that the microbes and the active agents can be incorporated into a controlled released formulation. In one embodiment, the microbes are released at a different rate from the active agents, and in other embodiments, the microbes and active agents can be released together. Preferably, the microbes are released separately from the active agents to avoid disabling the microbes by the active agents such as herbicide, pesticide, or fungicide. This can be done by coating the seeds with different time release materials that are activated at different times. For example, the modules with microbes are released first to provide grow nutrients to the seedlings, and the active agent can be released a week after to protect the plant. In a particular embodiment, the method of preparation may also further comprise adding at least one seed amendment material to the cross-linked hydrophilic polymer solution or mixture with microbes/active ingredients.

In an optional embodiment, the method of preparation may comprise preparing first and second suitable adhesive solutions, and a first cross-linked hydrophilic polymer powder and a second inactive inert powder. In one such embodiment, the method may also comprise coating the seed with a desired thickness or amount of the first adhesive solution and first cross-linked hydrophilic polymer powder. The method may also further comprise then coating the seed with a desired thickness or amount of the second adhesive solution and second inactive inert powder. In another optional embodiment, the method may comprise a plurality of steps comprising coating the seed with a desired thickness or amount of at least one of the cross-linked hydrophilic polymer powder, or inactive inert powder mixture, for example. In yet a further embodiment, the method may also further comprise drying the coated seed to a suitable or desired moisture content of the cross-linked hydrophilic polymer coating.

In a particular embodiment, the method of preparation may also further comprise adding at least one seed amendment material to the cross-linked hydrophilic polymer powder, solution or mixture. In a further particular embodiment, the step of coating the seed with a suitable or desired thickness of the cross-linked hydrophilic polymer may comprise one or more of wet or dry coating steps, and combinations thereof.

In a further embodiment of the present invention, a cross-linked hydrophilic hydrogel polymer coated seed may be provided comprising a seed, a first coating comprising a cross-linked hydrophilic polymer, and a second coating comprising an inactive inert material on top of the first coating. In another such embodiment, the cross-linked hydrophilic hydrogel polymer coated seed may further comprise a plurality of first coatings comprising a cross-linked hydrophilic polymer. In yet a further embodiment, at least one of the first and second coatings may additionally comprise an adhesive material.

The hydrogel used in the coating of the present invention is a cross-linked polymer that swells without dissolving in the presence of water, absorbing at least 10 times its weight in water. In view of the application in the environment, it is desirable that the hydrogel be one that is not an environmental pollutant. While the hydrogel may be a natural or a synthetic hydrogel, synthetic hydrogels have can be particularly advantageous in terms of water absorptivity and shelf life. Synthetic hydrogels are usually cross-linked polyacrylamides or cross-linked polyacrylates and have been reported to remain active for up to two years or more. Other examples of suitable hydrogels include those of carrageenan, agar and alginic acid, and gellan gum. In short, hydrogels, as the term is used herein, are super absorbent polymers capable of absorbing from 10 to over 100, such as 50 or even 80 to over 100, times their weight in water. Some hydrogels are able to absorb as much as 400 to 500 times their weight in water; others as much as 1,500 times their weight in water. In particular, Aridall Superabsorbent Polymer (potassium polyacrylate) and Aqualon Aquasorb (sodium carboxymethylcellulose) have been found suitable for use.

Multiple cross-linkings through serial repetition of the crosslinking method can be used to strengthen the hydrogel, leading to longer lasting hydrogels when inserted into soil. In one such embodiment, the cross-linked hydrophilic polymer coating on the coated seed may desirably facilitate at least one of: an increased moisture content surrounding the seed during planting, germination or initial growth of the seed, relative to an uncoated seed, for example. In a particular embodiment, the hydrophilic polymer material may comprise one or more cross-linked hydrophilic hydrogel and/or cellulose materials. In another particular embodiment, the coating on the plant seed may optionally be shaped in any convenient or desired shape, thickness or configuration, such as but not limited to a substantially uniform coating of a suitable desired thickness, in approximately the shape of the plant seed underlying the coating.

In one cross-linked embodiment, the type of molecular weight of the compound may be employed effectively to control the exact cross-linking time of the water-soluble solution. More particularly, suspensions of larger molecular weight material cross-link more slowly than suspensions of low molecular weight material. With respect to the particle size of the suspended material, as particle size increases, the time required for the cross-linking of a water-soluble polymer solution increases. Conversely, as the particle size decreases, the time required for the cross-linking of a water soluble decreases. The pH of the water soluble polymer solution prior to its cross-linking may be used to control cross-link time. The pH of the water soluble polymer solution affects the solubility rate of the stable, non-aqueous suspension of a delayed cross-linker. Specifically, as the pH of the water soluble polymer solution increases, the solubility rate of the cross-linker suspension increases if the suspension contains a majority of particles, whereas the solubility rate of the cross-linker suspension decreases if the suspension contains a majority of borax particles. Conversely, as the pH of the water soluble polymer solution decreases, the solubility rate of the cross-linker suspension decreases if the suspension contains a majority of boric acid particles, whereas the solubility rate of the cross-linker suspension increases if the suspension contains a majority of particles. Both the concentration (i.e., loading) of the stable, non-aqueous suspension of a delayed cross-linker in the water soluble polymer solution and the content of the cross-linker suspension affect the cross-link time of a water soluble polymer solution similarly. As either the concentration of the suspension of delayed cross-linker in the water-soluble polymer solution or the content of the cross-linker suspension increase, the cross-link time of the water soluble polymer solution decreases. Conversely, as either the concentration of the suspension of the delayed boron cross-linker in the water soluble polymer solution and the content of the cross-linker suspension decrease, the cross-link time of the water soluble polymer solution increases.

Temperature may be used to alter the cross-link time of a water soluble polymer solution. As the temperature of the water soluble polymer solution increases, its cross-link time decreases. Conversely, as the temperature of the water soluble polymer solution decreases, its cross-link time increases. Furthermore, the cross-link time of a water-soluble polymer may be increased or decreased depending upon the clay type utilized in the formulation of the stable, non-aqueous suspension of a delayed HA cross-linker. In addition, materials such as polymeric microspheres, polymer micelles, soluble polymers and hydrogel-type materials can be used for providing protection for chemicals against biochemical degradation.

In one embodiment, the linker is a dicarboxylic acid with at least three atoms between the carbonyls and contains a heteroatom alpha to the carbonyl forming the ester, the release half-life is less than about 10 hours; when Linker is a dicarboxylic acid with at least three atoms between the carbonyls with no heteroatom alpha to the carbonyl forming the ester, the release half-life is more than about 100 hours; wherein when Linker is a dicarboxylic acid with two atoms between the carbonyls and Tether contains a nitrogen with a reactive hydrogen, the release half-life of the HA is from about 0.1 hours to about 20 hours; wherein the release half-life being measured in 0.05M phosphate buffer, 0.9% saline, pH 7.4, at 37° C.; with the proviso that the conjugate is not PHF-SA-Gly-CPT, PHF-(methyl)SA-Gly-CPT, PHF-(2,2-dimethyl)SA-Gly-CPT, PHF-(2-nonen-2-yl)SA-Gly-CPT, PHF-SA-Gly-Taxol, or PHF-SA-Gly-Illudin. In some embodiments, the polyal is an acetal. In other embodiments, the polyal is a ketal. In some embodiments, the acetal is PHF. In some embodiments, Ri is H. In other embodiments, Ri is CH3. In some embodiments, R2 is —CH(Y)—C(O)—, wherein Y is one of the side chains of the naturally occurring amino acids. In some embodiments, R2 is an aryl group. In some embodiments, R2 is anheteroaryl group. In other embodiments, R2 is an aliphatic ring. In some embodiments, R2 is an aliphatic chain. In some embodiments, R2 is a heterocyclic aliphatic ring. In some embodiments, Ri and R2 when taken together with nitrogen to which they are attached form a ring.

In another cross-linked embodiment, the cross-linked hydrophilic coating material may comprise at least one suitable cross-linked hydrophilic hydrogel material, such as but not limited to: polyacrylamide, polyacrylate (such as polyhydroxymethylacrylate), polyvinyl alcohol, and sulphurated polystyrene hydrogel materials. In a particular embodiment, the at least one suitable cross-linked hydrophilic hydrogel material may comprise a cross-linked potassium polyacrylate hydrogel. In another particular embodiment, the at least one suitable cross-linked hydrophilic hydrogel material may comprise an enzymatically cross-linked cellulose hydrogel. According to another embodiment, in any of the exemplary embodiments described above or below, the cross-linked hydrophilic polymer coating may comprise at least one suitable hydrophilic hydrogel material which includes a first polymeric material having polyacrylic acid, and a second polymeric material having a polyglycol other than polyethylene glycol, where the first polymeric material is hydrogen-bonded to the second polymeric material. According to yet another embodiment, in any of the exemplary embodiments described above or below, the cross-linked hydrophilic polymer coating may comprise at least one suitable hydrophilic hydrogel material comprising a polyglycol comprising polytetramethylene ether glycol. In another optional embodiment, in any of the exemplary embodiments described above or below the cross-linked hydrophilic polymer coating may comprise at least one suitable hydrophilic hydrogel material comprising at least one suitable hydrophilic hydrogel material having a bulk porosity of at least 5%. In an alternate embodiment, the coating may optionally comprise at least one cross-linked hydrophilic cellulose material. In another embodiment, the cross-linked hydrophilic polymer coating may optionally comprise at least one suitable adhesive material, such as to provide for improved adhesion of the cross-linked hydrophilic polymer coating material. In one such embodiment, such adhesive materials may be particularly desirable in applications where the hydrophilic polymer coating is applied in a substantially dry or powder form, for example.

In one embodiment, the cross-linked hydrophilic polymer coating may additionally include at least one suitable seed amendment material, which may comprise at least one of: a suitable nutrient, fertilizer, pH control, herbicide, pesticide, or fungicide material, for example. In another embodiment, any suitable seed or plant nutrient material may be included in the cross-linked hydrophilic polymer seed coating, such as, but not limited to any suitable: fertilizer, nitrogen/nitrate, potassium, phosphorus, magnesium and/or calcium-containing nutrient materials, for example. In yet another embodiment, any suitable seed or plant pH control material may be included in the cross-linked hydrophilic polymer seed coating, such as but not limited to: acids, acid salts, acid-forming cations (such as sulfur for example), bases, basic salts, base-producing anions. In a further embodiment, any suitable seed and/or plant herbicide, pesticide or fungicide material may be included in the cross-linked hydrophilic polymer seed coating, such as may be suitable for countering any weed, pest or fungus found in a particular seed, storage, planting or soil environment desired for application of the cross-linked hydrophilic polymer coated seed, for example.

The coating for the seed includes a mixture of microbes and/or an active ingredient in a hydrogel. There may be some instances in which the precise identity of the type of the active ingredient is significant to the present invention. For instance, the present invention may provide an additional advantage with respect to a particular type of active ingredient over prior art application techniques or may provide an additional advantage with respect to certain active ingredients beyond those provided with respect to other active ingredients. However, the present invention is in the mechanism of application of active ingredients in general by incorporating them in a dry seed coating with a hydrogel. Therefore, in general, the precise identity and nature of the active ingredient is not important to the concept of this invention and so the nature or identity of the active ingredient should not be viewed as limiting in the scope of the present invention. In most cases, it is important only that the active ingredient be one that is designed to impart to the seed, plant or both a desired effect. Nevertheless, although this invention is not limited by the type of active agent in terms of what effect the agent is desired to produce, it is preferred that the active agent be a solid, especially a solid that may be granulated for dispersal throughout the coating, although liquids that are so dispersible and capable of being retained in the coating at desirable concentrations may be used as well. Examples of so retaining or dispersing liquids throughout a hydrogel matrix include agitating the liquid to form small globules that may then be dispersed throughout a solid hydrogel matrix, and encasing such small globules of liquid active agent in a solid shell and then dispersing the encased globules throughout a solid hydrogel matrix.

The term “active ingredient” as used herein also includes non-chemical agents, and basic growth aids, such as fertilizers, nutrients, and energy sources (e.g., sugars and other carbohydrates and ATP). The active ingredient may consist of a single type of active agent, or the active ingredient may consist of a combination of active agents. The active ingredient is simply any ingredient produces an effect on the seed or the plant that emerges from the seed, or on both the seed and the plant. The ingredient is applied to the seed because that effect is desired to produce in the seed, plant or both. Typically, the desired effect is one that is beneficial to the seed or plant. Thus, it is contemplated that essentially any effect on the seed or plant would be desired under some circumstances and so is contemplated within the scope herein. Active ingredients that can be employed in the coatings of the present invention may be any agent, such as a chemical agent, that produces a desired effect on the seed, the plant that ultimately emerges from the seed, or both. Non-limiting examples of such chemical agents include pesticides (such as fungicides, acaricides, miticides, insecticides, insect repellants, bird repellants, rodenticides, molluscicides, nematicides, bactericides, and fumigants), herbicides, chemical hybridizing agents, auxins, antibiotics and other drugs, biological attractants, growth regulators, pheromones and dyes. Specific non-limiting examples of chemical agents useful as active ingredients include triticonazole, imidacloprid, tefluthrin, and silthiophenamide (N-allyl-4,5-dimethyl-2-trimethylsilylthiophene-3-caboxamide).

By “controlled release formulation” what is meant is simply that incorporating the active agent into such formulation delays the release of the active agent into the surrounding environment and/or reduces the rate of release of the active agent into the surrounding environment. The controlled release formulation typically would employ an agent that impedes release of the active ingredient into the surrounding environment, thereby delaying the release or reducing the rate of release. The controlled release techniques may be employed in any of several ways (or in a combination of such ways). For instance, coated seeds of this invention may be encapsulated in a controlled release formulation, or the particles of active agent distributed through the hydrogel in the coating may be coated with a controlled release formulation, or the active agent may be mixed with the controlled release agent, or the controlled release agent may be dispersed through the coating. Any of these techniques may be used alone or in combination to enhance even further the controlled (i.e., delayed) release provided by either the controlled release formulation itself or the controlled release detected with the present invention even without such formulation.

The seeds and plants that can be used with the instant treatment can be of any species including corn, hemp, peanut, canola/rapeseed, soybean, curcubits, crucifers, cotton, rice, sorghum, sugar beet, wheat, barley, rye, sunflower, tomato, sugarcane, tobacco, oats, as well as other vegetable and leaf crops. The seed or plant can be transgenic and engineered to express a desirable characteristic and, in particular, to have at least one heterologous gene encoding for the expression of a protein that is pesticidally active and, in particular, has insecticidal activity. The heterologous gene in the transgenic seeds and plants of the present invention can be derived from a microorganism such as Bacillus, Rhizobium, Pseudomonas, Serratia, Trichoderma, Clavibacter, Glomus, Gliocladium and mycorrhizal fungi. In particular, it is believed that the present method would be especially beneficial when the heterologous gene is one that is derived from a Bacillus sp. microorganism and the protein is active against corn root worm. It is also believed that the present method would be especially beneficial when the heterologous gene is one that is derived from a Bacillus sp. microorganism and the protein is active against European corn borer. A preferred Bacillus sp. microorganism is Bacillus thuringiensis.

Non-limiting examples of such desired or desirable effects include increased protection from, resistance to or counteraction to pests (such as mites or other acarids, fungi, bacteria, insects, birds, mollusks, rodents, and nematodes), disease, herbicides or other potentially phyto-toxic chemicals, increased weather tolerance, or improved size, quantity, taste, scent, appearance, texture, growth rate, or harvesting, shipping, storage or handling qualities of the seeds, plants or seeds, fruits or vegetables borne by the plants. Although reference is made herein at times to imparting the desired effect to the seed or plant, it should be understood that such language is used in a broad sense in that the effect need not be a characteristic of the seed or plant itself, but may be the result of the proximity of the active ingredient to the seed or plant. For example, increased pest resistance of a coated seed may be the result of a protective barrier associated with the coating rather than a change in the internal chemistry or biology of the seed. Yet, for the purposes of this disclosure, the seed is considered to have been imparted with the desired effect of pest resistance.

As noted above, the seed coating of the present invention is dry. As used herein, “dry” refers to water content. It should be recognized, however, that “dry” is a relative term and that it is difficult if not impossible to maintain a mixture containing such hydrophilic material as a hydrogel 100% water-free. Thus, recognizing such constraints, as used herein, the term “dry” means that the material that is dry is not gelatinous or tacky, but has the appearance and feel of a solid. Quantitatively, “dry”, as used herein, means a water content of less than 4% of the saturation water content of the hydrogel, the saturation water content being the maximum amount of water the hydrogel in the mixture in question can absorb at ambient temperature and pressure. Thus, for instance, a dry coating containing a hydrogel that can absorb 100 times its weight in water has a water content of less than 4 times the weight of the hydrogel. Preferably, however, the water content of the dry coatings of the present invention is less than that of the hydrogel content, by weight. More preferably, the water content of the dry coating is less than about 10% by weight of the coating, even more preferably, less than about 1% by weight of the coating. The water content referred to herein relates to the free water in the hydrogel such that if, for example, the active ingredient is distributed throughout the hydrogel in the form of encapsulated globules of aqueous mixture of active ingredient, the water within the encapsulations is not considered in determining the water content of the coating.

A variety of techniques for applying coatings to seeds are known in the art and may be used for coating the seeds of this invention, provided that the resulting coating is dry as defined above. Thus, those of ordinary skill in the art, upon reading this disclosure, will readily recognize certain techniques that may be employed. The formulation may be applied to the seeds using conventional coating techniques and machines, such as fluidized bed techniques, the roller mill method, rotostatic seed treaters, and drum coaters. Other methods, such as spouted beds may also be useful. The seeds may be presized before coating. After coating, the seeds are typically dried and then transferred to a sizing machine for sizing. Such procedures are known in the art. Generally, however, the techniques fall into either of two classes, one in which a high water content mixture of hydrogel and active ingredient is added to the seed and then water is removed (referred to herein as the wet process), and the other in which a relatively dry mixture of hydrogel and active ingredient is applied to the seed (referred to herein as the dry process). An initial step according to the wet process, is preparation of a wet mixture of hydrogel and active ingredient. The wet mixture may be prepared in any of several ways. For example, the active ingredient, which (as explained above) may be a single active agent or a combination of active agents, may be mixed with water to form an aqueous solution and then the hydrogel may be mixed into the aqueous solution. Alternatively, the active ingredient may be mixed with the hydrogel or otherwise added to the water simultaneously with the hydrogel. Or, the hydrogel may be mixed with the water, followed by addition of the active ingredient to the aqueous hydrogel mixture. If the active ingredient consists of more than one agent, the various agents can be combined to form a mixture that is added to the water or to the aqueous hydrogel mixture or the various agents can be combined with the water or aqueous hydrogel mixture without mixing them together first. Or else, if so desired, the various agents can be added at various stages during the preparation of the wet mixture. Low water concentrations in the wet mixture are preferred, and generally only enough water to reduce the viscosity to a level to allow convenient handling is used. Other additives, such as fillers (e.g., diatomaceous earth, calcium carbonate, or silica) may be incorporated into the wet mixture as well. The wet mixture may be applied to seeds by any standard techniques for applying liquids to seeds. For example, the coating process can comprise spraying a composition comprising the formulation onto the seed while agitating the seed in an appropriate piece of equipment such as a tumbler or a pan granulator. The wet mixture may then be applied to the seed or seeds by conventional seed-coating techniques. For example, the coating process can comprise spraying a composition comprising the formulation onto the seed while agitating the seed in an appropriate piece of equipment such as a tumbler or a pan granulator.

In one embodiment, when coating seed on a large scale (for example a commercial scale), typically seed is introduced into the treatment equipment (such as a tumbler, a mixer, or a pan granulator) either by weight or by flow rate. The amount of treatment composition of microbes and active ingredients introduced into the treatment equipment can vary depending on the seed weight to be coated, surface area of the seed, the concentration of the active ingredient in the controlled release formulation, the desired concentration on the finished seed, and the like. The treatment composition can be applied to the seed by a variety of means, for example by a spray nozzle or revolving disc. The amount of liquid is typically determined by the assay of the formulation and the required rate of active ingredient necessary for efficacy. As the seed falls into the treatment equipment the seed can be treated (for example by misting or spraying with the seed treatment composition) and passed through the treater under continual movement/tumbling where it can be coated evenly and dried before storage or use. In another embodiment, a known weight of seeds can be introduced into the treatment equipment (such as a tumbler, a mixer, or a pan granulator). A known volume of seed treatment composition can be introduced into the treatment equipment at a rate that allows the seed treatment composition to be applied evenly over the seeds. During the application, the seed can be mixed, for example by spinning or tumbling. The seed can optionally be dried or partially dried during the tumbling operation. After complete coating, the treated sample can be removed to an area for further drying or additional processing, use, or storage.

In still another embodiment, seeds can be coated in laboratory size commercial treatment equipment such as a tumbler, a mixer, or a pan granulator by introducing a known weight of seeds in the treater, adding the desired amount of seed treatment composition, tumbling or spinning the seed and placing it on a tray to thoroughly dry. In another embodiment, seeds can also be coated by placing the known amount of seed into a narrow neck bottle or receptacle with a lid. While tumbling, the desired amount of seed treatment composition can be added to the receptacle. The seed is tumbled until it is coated with the seed treatment composition. After coating, the seed can optionally be dried, for example on a tray, with a desiccant or mild heat (such as below about 40° C.) to produce a dry coating.

Alternatively, a dry method, also involves two steps. The first step involves application of a “sticking agent” as an adhesive film over the seed so that the hydrogel/active ingredient mixture in the form of a powder can be bonded to the seed to form the coating of this invention. The film may be a thin coating of wet hydrogel, with or without active ingredient. Alternatively, a quantity of seed can be mixed with a sticking agent, such as polyethylene glycol, and optionally agitated to encourage uniform coating of the seed with the sticking agent. In the second step, the seed coated with the sticking agent can then be mixed with the powdered mixture of hydrogel and active agent. The dry formulation of hydrogel and active ingredient may contain other additives as discussed above with respect to the wet mixture. The seed and powdered hydrogel and active ingredient mixture can be agitated, for example by tumbling, to encourage contact of the sticking agent with the powdered material, thereby causing the powdered material to stick to the seed.

In one embodiment, seeds are coated for ease of handling, singulation, precision placement and the incorporation of beneficial chemicals and/or microbials. Microbes are used to enhance growth, in particular at seedling stage, and is generally released first in time. The seeds also need fungicides, so the microbes and the fungicides are activated separately in their own time release capsules to maximize results. Fungicides are another example of an enhancement applied to seed to protect vulnerable seedlings from various fungal diseases. Dust or slurry dithiocarbamate treatments can be used, among others. Fungicide treatments can be combined with film coatings and thereby applied at even more dosage rates, simultaneously eliminating dust off for a cleaner safer product. Powder coatings achieve similar results by blending precise amounts of fungicides in the coating powder for nearly identical dosage on each seed. Then a final layer of coating powder without fungicide can be applied at the end of the coating process, eliminating the chemical from the pill surface.

In one embodiment, seed coating operations put seed in a rotating pan, mist with water or other liquid and gradually add a fine inert powder, e.g., Diatomaceous earth, to the coating pan. Each misted seed becomes the center of an agglomeration of powder that gradually increases in size. The pills are rounded and smoothed by the tumbling action in the pan, similar to pebbles on the beach. The coating powder is compacted compression from the weight of material in the pan.

Binders can be incorporated near the end of the coating process to harden the outer layer of the pill. Binders can also reduce the amount of dust produced by the finished product in handling, shipping and sowing. Care must be taken with binders to avoid delaying or reducing the germination percentage.

Blanks and doubles are eliminated by intensive screening and other techniques. Uniform size and uniform rate of increase in size are evaluated throughout the process with frequent hand screening. At intervals during coating, and at the end, all of the pills are removed and mechanically sized on a set of vibrating screens. Smaller pills are returned to the pan and built up to the size of the remainder of the lot. After drying, usually with a forced air system at controlled, moderate temperatures, the pills are screened a final time before packaging. Undersized pills may be built up or discarded. The recovery rate (number of pills divided by the original number of seeds) has been 97%+/−2% for commercial seed lots at one commercial company for the past 10 years.

Size uniformity after coating is a major criterion of coating quality. The usual tolerance for coated seed is +/− 1/64th inch (0.4 mm). This is the US seed trade standard for sizing, established long before coatings were introduced. For example, coated lettuce seed is sown most frequently with a belt planter through a 13/64 inch diameter round holes in the belt. This hole size requires that the lettuce pills be sized over a 7.5/64 inch screen and through an 8.5/64 inch screen. These tolerances result in levels of singulation well above 95% in the field with placement in the row controlled within <½ inch.

In an example, commercially available hemp seeds were coated with a microbial mixture to improve yield from Plant-Grow Inc. of Zephyr Cove, Nev., cross-linked hydrophilic polymer, specifically an exemplary cross-linked potassium polyacrylate hydrophilic hydrogel polymer, available from mOasis Inc. of Union City, Calif., as BountiGel™ hydrogel. After coating, hemp seeds coated with the potassium polyacrylate hydrophilic polymer were subjected to a standard warm germination test as detailed below.

In the example, an Aginnovation Rotary-6 rotary seed coating machine available from Aginnovation LLC, of Walnut Grove, Calif., USA, was used for coating the hemp seeds. Two adhesive solutions were prepared for facilitating coating of the hemp seeds with the cross-linked hydrophilic polymer hydrogel. A first adhesive Solution A was prepared as a 20% (w/v) solution of polyvinylpyrrolidone (obtained as PVP40 available from Sigma Aldrich of St. Louis, Mo., USA) in dichloromethane (270997 from Sigma Aldrich). A second adhesive Solution B was prepared as a 20% (w/v) solution of polyvinyl acetate (189480 from Sigma Aldrich) in dichloromethane (270997 from Sigma Aldrich). Two coating powder formulations were prepared for coating on the seeds. A first cross-linked hydrophilic hydrogel polymer Powder Formulation 1 was prepared by blending 5 g of cross-linked potassium polyacrylate hydrophilic hydrogel polymer powder (BountiGel™ hydrogel polymer powder from mOasis Inc.) with 5 g of talc powder (243604 from Sigma Aldrich). A second coating Powder Formulation 2 was prepared by blending 1 g of potato starch powder (S4251 from Sigma Aldrich) with 9 g of talc powder (243604 from Sigma Aldrich).

The exemplary hemp seeds were then coated using the rotary seed coating machine at a rotary speed setting of about 200-600 rpm. A 200 g sample of hemp seeds were loaded into the rotary chamber of the seed coating machine. A 6 mL volume of adhesive solution A was added to the seeds in the chamber via a spinning atomizing disk at a rate of 2 mL/minute. Following the addition of adhesive Solution A, a 3 g quantity of Powder Formulation 1 was added to the seeds at a rate of 2 g/minute. Then a second exemplary 6 mL volume of adhesive solution A was added to the seeds in the chamber via the atomizing disk at a rate of 2 mL/minute, followed by another exemplary 3 g of Powder Formulation 1 added at a rate of 2 g/minute. Then an exemplary 5 mL volume of adhesive Solution B was added to the seeds in the chamber via a spinning atomizing disk at a rate of 2 mL/minute, followed by an exemplary 2 g quantity of Powder Formulation 2 which was added to the seeds at a rate of 2 g/minute. Following the above coating procedure, the coated hemp seeds were transferred to a stainless steel plate (exemplary 30 cm×45 cm stainless plate) and allowed to dry under a fume hood for about 30 minutes.

The microbial compositions of the present invention can be formulated as a seed or fertilizer treatment. It is contemplated that the seeds/fertilizer can be substantially uniformly coated with one or more layers of the microbial compositions disclosed herein using conventional methods of mixing, spraying or a combination thereof through the use of treatment application equipment that is specifically designed and manufactured to accurately, safely, and efficiently apply seed treatment products to seeds. Such equipment uses various types of coating technology such as rotary coaters, drum coaters, fluidized bed techniques, spouted beds, rotary mists or a combination thereof. Liquid seed treatments such as those of the present invention can be applied via either a spinning “atomizer” disk or a spray nozzle which evenly distributes the seed treatment onto the seed as it moves though the spray pattern. Preferably, the seed is then mixed or tumbled for an additional period of time to achieve additional treatment distribution and drying. The seeds/fertilizer can be primed or unprimed before coating with the inventive compositions to increase the uniformity of germination and emergence. In an alternative embodiment, a dry powder formulation can be metered onto the moving seed and allowed to mix until completely distributed. The microbes can be coated freely onto the seeds/fertilizer or, preferably, they can be formulated in a liquid or solid composition before being coated onto the seeds. For example, a solid composition comprising the microorganisms can be prepared by mixing a solid carrier with a suspension of the spores until the solid carriers are impregnated with the microbial suspension. This mixture can then be dried to obtain the desired particles.

In some other embodiments, it is contemplated that the solid or liquid microbial compositions of the present invention further contain functional agents capable of protecting seeds from the harmful effects of selective herbicides such as activated carbon, nutrients (fertilizers), and other agents capable of improving the germination and quality of the products or a combination thereof.

A variety of additives can be added to the seed or fertilizer treatment formulations comprising the inventive compositions. Binders can be added and include those composed preferably of an adhesive polymer that can be natural or synthetic without phytotoxic effect on the seed to be coated. The binder may be selected from polyvinyl acetates; polyvinyl acetate copolymers; ethylene vinyl acetate (EVA) copolymers; polyvinyl alcohols; polyvinyl alcohol copolymers; celluloses, including ethylcelluloses, methylcelluloses, hydroxymethylcelluloses, hydroxypropylcelluloses and carboxymethylcellulose; polyvinylpyrolidones; polysaccharides, including starch, modified starch, dextrins, maltodextrins, alginate and chitosans; fats; oils; proteins, including gelatin and zeins; gum arabics; shellacs; vinylidene chloride and vinylidene chloride copolymers; calcium lignosulfonates; acrylic copolymers; polyvinylacrylates; polyethylene oxide; acrylamide polymers and copolymers; polyhydroxyethyl acrylate, methylacrylamide monomers; and polychloroprene.

Any of a variety of colorants may be employed, including organic chromophores classified as nitroso; nitro; azo, including monoazo, bisazo and polyazo; acridine, anthraquinone, azine, diphenylmethane, indamine, indophenol, methine, oxazine, phthalocyanine, thiazine, thiazole, triarylmethane, xanthene. Other additives that can be added include trace nutrients such as salts of iron, manganese, boron, copper, cobalt, molybdenum and zinc. A polymer or other dust control agent can be applied to retain the treatment on the seed surface.

Various additives, such as adherents, dispersants, surfactants, and nutrient and buffer ingredients, can also be included in the seed treatment formulation. Other conventional seed treatment additives include, but are not limited to, coating agents, wetting agents, buffering agents, and polysaccharides. At least one agriculturally acceptable carrier can be added to the seed treatment formulation such as water, solids or dry powders. The dry powders can be derived from a variety of materials such as calcium carbonate, gypsum, vermiculite, talc, humus, activated charcoal, and various phosphorous compounds.

In some embodiment, the seed coating composition can comprise at least one filler which is an organic or inorganic, natural or synthetic component with which the active components are combined to facilitate its application onto the seed. Preferably, the filler is an inert solid such as clays, natural or synthetic silicates, silica, resins, waxes, solid fertilizers (for example ammonium salts), natural soil minerals, such as kaolins, clays, talc, lime, quartz, attapulgite, montmorillonite, bentonite or diatomaceous earths, or synthetic minerals, such as silica, alumina or silicates, in particular aluminium or magnesium silicates.

The seed or fertilizer treatment formulation may further include one or more of the following ingredients: other pesticides, including compounds that act only below the ground; fungicides, such as captan, thiram, metalaxyl, fludioxonil, oxadixyl, and isomers of each of those materials, and the like; herbicides, including compounds selected from glyphosate, carbamates, thiocarbamates, acetamides, triazines, dinitroanilines, glycerol ethers, pyridazinones, uracils, phenoxys, ureas, and benzoic acids; herbicidal safeners such as benzoxazine, benzhydryl derivatives, N,N-diallyl dichloroacetamide, various dihaloacyl, oxazolidinyl and thiazolidinyl compounds, ethanone, naphthalic anhydride compounds, and oxime derivatives; chemical fertilizers; biological fertilizers; and biocontrol agents such as other naturally-occurring or recombinant bacteria and fungi from the genera Rhizobium, Bacillus, Pseudomonas, Serratia, Trichoderma, Glomus, Gliocladium and mycorrhizal fungi. These ingredients may be added as a separate layer on the seed or alternatively may be added as part of the seed coating composition of the invention. The formulation that is used to treat the seed in the present invention can be in the form of a suspension; emulsion; slurry of particles in an aqueous medium (e.g., water); wettable powder; wettable granules (dry flowable); and dry granules. If formulated as a suspension or slurry, the concentration of the active ingredient in the formulation is preferably about 0.5% to about 99% by weight (w/w), preferably 5-40% or as otherwise formulated by those skilled in the art. Other conventional inactive or inert ingredients can be incorporated into the formulation. Such inert ingredients include but are not limited to: conventional sticking agents; dispersing agents such as methylcellulose, for example, serve as combined dispersant/sticking agents for use in seed treatments; polyvinyl alcohol; lecithin, polymeric dispersants (e.g., polyvinylpyrrolidone/vinyl acetate); thickeners (e.g., clay thickeners to improve viscosity and reduce settling of particle suspensions); emulsion stabilizers; surfactants; antifreeze compounds (e.g., urea), dyes, colorants, and the like.

The seed coating formulations of the present invention may be applied to the seeds using a variety of techniques and machines, such as fluidized bed techniques, the roller mill method, rotostatic seed treaters, and drum coaters. Other methods, such as spouted beds may also be useful. The seeds may be pre-sized before coating. After coating, the seeds are typically dried and then transferred to a sizing machine for sizing. Such procedures are known in the art. The microorganism-treated seeds may also be enveloped with a film overcoating to protect the coating. Such overcoatings are known in the art and may be applied using fluidized bed and drum film coating techniques. Compositions according to the present invention can be introduced onto a seed by use of solid matrix priming. For example, a quantity of an inventive composition can be mixed with a solid matrix material and then the seed can be placed into contact with the solid matrix material for a period to allow the composition to be introduced to the seed. The seed can then optionally be separated from the solid matrix material and stored or used, or the mixture of solid matrix material plus seed can be stored or planted directly. Solid matrix materials which are useful in the present invention include polyacrylamide, starch, clay, silica, alumina, soil, sand, polyurea, polyacrylate, or any other material capable of absorbing or adsorbing the inventive composition for a time and releasing that composition into or onto the seed. It is useful to make sure that the inventive composition and the solid matrix material are compatible with each other. For example, the solid matrix material should be chosen so that it can release the composition at a reasonable rate, for example over a period of minutes, hours, or days.

For seed coating, any plant seed capable of germinating to form a plant can be treated in accordance with the invention. Suitable seeds include those of cereals, coffee, cole crops, fiber crops, flowers, fruits, legume, oil crops, trees, tuber crops, vegetables, as well as other plants of the monocotyledonous, and dicotyledonous species. Preferably, crop seeds are coated include, but are not limited to, bean, carrot, corn, cotton, grasses, lettuce, peanut, pepper, potato, rapeseed, rice, rye, sorghum, soybean, sugarbeet, sunflower, tobacco, and tomato seeds. Most preferably, barley or wheat (spring wheat or winter wheat) seeds are coated with the present compositions.

Next, processes to analyze soil condition and identify microorganisms capable of imparting one or more beneficial property to one or more phases of a resulting plant product. For example, the end product can be wine for grape through a fermentation process. The variability in the microbial populations present in the sample can be used to support a directed process of selection of one or more microorganisms for use in a phase of a fermentation process and for identifying particular combinations and abundances of microorganisms which are of benefit for a particular purpose. In other embodiment, the microorganisms can be optimized for hemp oil, cannabis oil, or canola oil extraction and purification, for example. The methods may be used as a part of a plant breeding program. The methods may allow for, or at least assist with, the selection of plants which have a particular genotype/phenotype which is influenced by the microbial flora, in addition to identifying microorganisms and/or compositions that are capable of imparting one or more property to one or more plants. Such beneficial properties include, but are not limited to, for example: improved growth, health and/or survival characteristics, suitability or quality of the plant for a particular purpose, structure, color, chemical composition or profile, taste, smell, improved quality. In other embodiments, beneficial properties include, but are not limited to, for example; decreasing, suppressing or inhibiting the growth of a plant; constraining the height and width of a plant to a desirable size; regulate production of and/or response to plant pheromones (resulting in increased tannin production in surrounding plant community and decreased appeal to foraging species).

In one aspect, a method for the selection of one or more microorganism(s) is disclosed for imparting one or more beneficial property to a plant to be used as raw material in a fermentation process. In other words, the process will allow for enrichment of suitable microorganisms within the plant microbiome. Such microorganism(s) may be contained within a plant, on a plant, and/or within the plant's growing soil or water. It should be appreciated that as referred to herein a “beneficial property to a plant” should be interpreted broadly to mean any property which is beneficial for any particular purpose including properties which may be beneficial to human beings, other animals, the environment, a habitat, an ecosystem, the economy, of commercial benefit, or of any other benefit to any entity or system. Accordingly, the term should be taken to include properties which may suppress, decrease or block one or more characteristic of a plant, including suppressing, decreasing or inhibiting the growth or growth rate of a plant. The invention may be described herein, by way of example only, in terms of identifying positive benefits to one or more plants or improving plants. However, it should be appreciated that the invention is equally applicable to identifying negative benefits that can be conferred to plants.

In yet another embodiment is provided a process including: analyzing a material from a location associated with a fermentation process; obtaining microbiome information, selected from real time microbiome information, derived microbiome information and predictive microbiome information; and performing an evaluation on the microbiome information, the evaluation including: a relationship based processing including a related genetic material component and a fermentation setting component; and a bioinformatics stage; whereby the evaluation provides information to direct the fermentation process.

In some embodiments, determining a profile of the microbiome in said sample can be based on 50 or fewer microbes, 55 or fewer microbes, 60 or fewer microbes, 65 or fewer microbes, 70 or fewer microbes, 75 or fewer microbes, 80 or fewer microbes, 85 or fewer microbes, 90 or fewer microbes, 100 or fewer microbes, 200 or fewer microbes, 300 or fewer microbes, 400 or fewer microbe, 500 or fewer microbes, 600 or fewer microbes, 700 or fewer microbes, or 800 or fewer microbes. In some embodiments determining a profile of the microbiome in said sample has an accuracy greater than 70% based on the measurements. In some embodiments, analyzing uses long read sequencing platforms.

Any microbiome profile described herein can include one or more, but are not limited to the following microbes:

Abiotrophia, Abiotrophia defectiva, Abiotrophia, Acetanaerobacterium, Acetanaerobacterium elongatum, Acetanaerobacterium, Acetivibrio, Acetivibrio bacterium, Acetivibrio, Acetobacterium, Acetobacterium, Acetobacterium woodii, Acholeplasma, Acholeplasma, Acidaminococcus, Acidaminococcus fermentans, Acidaminococcus, Acidianus, Acidianus brierleyi, Acidianus, Acidovorax, Acidovorax, Acinetobacter, Acinetobacter guillouiae, Acinetobacter junii, Acinetobacter, Actinobacillus, Actinobacillus M1933/96/1, Actinomyces, Actinomyces ICM34, Actinomyces ICM41, Actinomyces ICM54, Actinomyces lingnae, Actinomyces odontolyticus, Actinomyces oral, Actinomyces ph3, Actinomyces, Adlercreutzia, Adlercreutzia equolifaciens, Adlercreutzia intestinal, Adlercreutzia, Aerococcus, Aerococcus, Aeromonas, Aeromonas 165C, Aeromonas hydrophila, Aeromonas RC50, Aeromonas, Aeropyrum, Aeropyrum pernix, Aeropyrum, Aggregatibacter, Aggregatibacter, Agreia, Agreia bicolorata, Agreia, Agromonas, Agromonas CS30, Akkermansia, Akkermansia muciniphila, Akkermansia, Alistipes, Alistipes ANTI, Alistipes AP11, Alistipes bacterium, Alistipes CCUG, Alistipes DJF B185, Alistipes DSM, Alistipes EBA6-25c12, Alistipes finegoldii, Alistipes indistinctus, Alistipes JC136, Alistipes NML05A004, Alistipes onderdonkii, Alistipes putredinis, Alistipes RMA, Alistipes senegalensis, Alistipes shahii, Alistipes Smarlab, Alistipes, Alkalibaculum, Alkalibaculum, Alkaliflexus, Alkaliflexus, Allisonella, Allisonella histaminiformans, Allisonella, Alloscardovia, Alloscardovia omnicolens, Anaerofilum, Anaerofilum, Anaerofustis, Anaerofustis stercorihominis, Anaerofustis, Anaeroplasma, Anaeroplasma, Anaerostipes, Anaerostipes 08964, Anaerostipes ly-2, Anaerostipes 494a, Anaerostipes 5-1-63FAA, Anaerostipes AIP, Anaerostipes bacterium, Anaerostipes butyraticus, Anaerostipes caccae, Anaerostipes hadrum, Anaerostipes 1E4, Anaerostipes indolis, Anaerostipes, Anaerotruncus, Anaerotruncus colihominis, Anaerotruncus NML, Anaerotruncus, Aquincola, Aquincola, Arcobacter, Arcobacter, Arthrobacter, Arthrobacter FV1-1, Asaccharobacter, Asaccharobacter celatus, Asaccharobacter, Asteroleplasma, Asteroleplasma, Atopobacter, Atopobacter phocae, Atopobium, Atopobium parvulum, Atopobium rimae, Atopobium, Bacteriovorax, Bacteriovorax, Bacteroides, Bacteroides 31SF 18, Bacteroides 326-8, Bacteroides 35AE31, Bacteroides 35AE37, Bacteroides 35BE34, Bacteroides 4072, Bacteroides 7853, Bacteroides acidifaciens, Bacteroides AP1, Bacteroides AR20, Bacteroides AR29, Bacteroides B2, Bacteroides bacterium, Bacteroides barnesiae, Bacteroides BLBE-6, Bacteroides BV-1, Bacteroides caccae, Bacteroides CannelCatfish9, Bacteroides cellulosilyticus, Bacteroides chinchillae, Bacteroides CIP 103040, Bacteroides clarus, Bacteroides coprocola, Bacteroides coprophilus, Bacteroides D8, Bacteroides DJF B097, Bacteroides dnLKV2, Bacteroides dnLKV7, Bacteroides dnLKV9, Bacteroides dorei, Bacteroides EBA5-17, Bacteroides eggerthii, Bacteroides enrichment, Bacteroides F-4, Bacteroides faecichinchillae, Bacteroides faecis, Bacteroides fecal, Bacteroides finegoldii, Bacteroides fragilis, Bacteroides gallinarum, Bacteroides helcogenes, Bacteroides ic1292, Bacteroides intestinalis, Bacteroides massiliensis, Bacteroides mpnisolate, Bacteroides NB-8, Bacteroides new, Bacteroides nlaezlc13, Bacteroides nlaezlc158, Bacteroides nlaezlc159, Bacteroides nlaezlc161, Bacteroides nlaezlc163, Bacteroides nlaezlc167, Bacteroides nlaezlc172, Bacteroides nlaezlc18, Bacteroides nlaezlc182, Bacteroides nlaezlc190, Bacteroides nlaezlc198, Bacteroides nlaezlc204, Bacteroides nlaezlc205, Bacteroides nlaezlc206, Bacteroides nlaezlc207, Bacteroides nlaezlc211, Bacteroides nlaezlc218, Bacteroides nlaezlc257, Bacteroides nlaezlc260, Bacteroides nlaezlc261, Bacteroides nlaezlc263, Bacteroides nlaezlc308, Bacteroides nlaezlc315, Bacteroides nlaezlc322, Bacteroides nlaezlc324, Bacteroides nlaezlc331, Bacteroides nlaezlc339, Bacteroides nlaezlc36, Bacteroides nlaezlc367, Bacteroides nlaezlc375, Bacteroides nlaezlc376, Bacteroides nlaezlc380, Bacteroides nlaezlc391, Bacteroides nlaezlc459, Bacteroides nlaezlc484, Bacteroides nlaezlc501, Bacteroides nlaezlc504, Bacteroides nlaezlc515, Bacteroides nlaezlc519, Bacteroides nlaezlc532, Bacteroides nlaezlc557, Bacteroides nlaezlc57, Bacteroides nlaezlc574, Bacteroides nlaezlc592, Bacteroides nlaezlg105, Bacteroides nlaezlg117, Bacteroides nlaezlg127, Bacteroides nlaezlg136, Bacteroides nlaezlg143, Bacteroides nlaezlg157, Bacteroides nlaezlg167, Bacteroides nlaezlg171, Bacteroides nlaezlg187, Bacteroides nlaezlg194, Bacteroides nlaezlg195, Bacteroides nlaezlg199, Bacteroides nlaezlg209, Bacteroides nlaezlg212, Bacteroides nlaezlg213, Bacteroides nlaezlg218, Bacteroides nlaezlg221, Bacteroides nlaezlg228, Bacteroides nlaezlg234, Bacteroides nlaezlg237, Bacteroides nlaezlg24, Bacteroides nlaezlg245, Bacteroides nlaezlg257, Bacteroides nlaezlg27, Bacteroides nlaezlg285, Bacteroides nlaezlg288, Bacteroides nlaezlg295, Bacteroides nlaezlg296, Bacteroides nlaezlg303, Bacteroides nlaezlg310, Bacteroides nlaezlg312, Bacteroides nlaezlg327, Bacteroides nlaezlg329, Bacteroides nlaezlg336, Bacteroides nlaezlg338, Bacteroides nlaezlg347, Bacteroides nlaezlg356, Bacteroides nlaezlg373, Bacteroides nlaezlg376, Bacteroides nlaezlg380, Bacteroides nlaezlg382, Bacteroides nlaezlg385, Bacteroides nlaezlg4, Bacteroides nlaezlg422, Bacteroides nlaezlg437, Bacteroides nlaezlg454, Bacteroides nlaezlg455, Bacteroides nlaezlg456, Bacteroides nlaezlg458, Bacteroides nlaezlg459, Bacteroides nlaezlg46, Bacteroides nlaezlg461, Bacteroides nlaezlg475, Bacteroides nlaezlg481, Bacteroides nlaezlg484, Bacteroides nlaezlg5, Bacteroides nlaezlg502, Bacteroides nlaezlg515, Bacteroides nlaezlg518, Bacteroides nlaezlg521, Bacteroides nlaezlg54, Bacteroides nlaezlg6, Bacteroides nlaezlg8, Bacteroides nlaezlg80, Bacteroides nlaezlg98, Bacteroides nlaezlh120, Bacteroides nlaezlh15, Bacteroides nlaezlh162, Bacteroides nlaezlh17, Bacteroides nlaezlh174, Bacteroides nlaezlh18, Bacteroides nlaezlh188, Bacteroides nlaezlh192, Bacteroides nlaezlh194, Bacteroides nlaezlh195, Bacteroides nlaezlh207, Bacteroides nlaezlh22, Bacteroides nlaezlh250, Bacteroides nlaezlh251, Bacteroides nlaezlh28, Bacteroides nlaezlh313, Bacteroides nlaezlh319, Bacteroides nlaezlh321, Bacteroides nlaezlh328, Bacteroides nlaezlh334, Bacteroides nlaezlh390, Bacteroides nlaezlh391, Bacteroides nlaezlh414, Bacteroides nlaezlh416, Bacteroides nlaezlh419, Bacteroides nlaezlh429, Bacteroides nlaezlh439, Bacteroides nlaezlh444, Bacteroides nlaezlh45, Bacteroides nlaezlh46, Bacteroides nlaezlh462, Bacteroides nlaezlh463, Bacteroides nlaezlh465, Bacteroides nlaezlh468, Bacteroides nlaezlh471, Bacteroides nlaezlh472, Bacteroides nlaezlh474, Bacteroides nlaezlh479, Bacteroides nlaezlh482, Bacteroides nlaezlh49, Bacteroides nlaezlh493, Bacteroides nlaezlh496, Bacteroides nlaezlh497, Bacteroides nlaezlh499, Bacteroides nlaezlh50, Bacteroides nlaezlh531, Bacteroides nlaezlh535, Bacteroides nlaezlh8, Bacteroides nlaezlp104, Bacteroides nlaezlp105, Bacteroides nlaezlp108, Bacteroides nlaezlp132, Bacteroides nlaezlp133, Bacteroides nlaezlp151, Bacteroides nlaezlp157, Bacteroides nlaezlp166, Bacteroides nlaezlp167, Bacteroides nlaezlp171, Bacteroides nlaezlp178, Bacteroides nlaezlp187, Bacteroides nlaezlp191, Bacteroides nlaezlp196, Bacteroides nlaezlp208, Bacteroides nlaezlp213, Bacteroides nlaezlp228, Bacteroides nlaezlp233, Bacteroides nlaezlp267, Bacteroides nlaezlp278, Bacteroides nlaezlp282, Bacteroides nlaezlp286, Bacteroides nlaezlp295, Bacteroides nlaezlp299, Bacteroides nlaezlp301, Bacteroides nlaezlp302, Bacteroides nlaezlp304, Bacteroides nlaezlp317, Bacteroides nlaezlp319, Bacteroides nlaezlp32, Bacteroides nlaezlp332, Bacteroides nlaezlp349, Bacteroides nlaezlp35, Bacteroides nlaezlp356, Bacteroides nlaezlp370, Bacteroides nlaezlp371, Bacteroides nlaezlp376, Bacteroides nlaezlp395, Bacteroides nlaezlp402, Bacteroides nlaezlp403, Bacteroides nlaezlp409, Bacteroides nlaezlp412, Bacteroides nlaezlp436, Bacteroides nlaezlp438, Bacteroides nlaezlp440, Bacteroides nlaezlp447, Bacteroides nlaezlp448, Bacteroides nlaezlp451, Bacteroides nlaezlp476, Bacteroides nlaezlp478, Bacteroides nlaezlp483, Bacteroides nlaezlp489, Bacteroides nlaezlp493, Bacteroides nlaezlp557, Bacteroides nlaezlp559, Bacteroides nlaezlp564, Bacteroides nlaezlp565, Bacteroides nlaezlp572, Bacteroides nlaezlp573, Bacteroides nlaezlp576, Bacteroides nlaezlp591, Bacteroides nlaezlp592, Bacteroides nlaezlp631, Bacteroides nlaezlp633, Bacteroides nlaezlp696, Bacteroides nlaezlp7, Bacteroides nlaezlp720, Bacteroides nlaezlp730, Bacteroides nlaezlp736, Bacteroides nlaezlp737, Bacteroides nlaezlp754, Bacteroides nlaezlp759, Bacteroides nlaezlp774, Bacteroides nlaezlp828, Bacteroides nlaezlp854, Bacteroides nlaezlp860, Bacteroides nlaezlp886, Bacteroides nlaezlp887, Bacteroides nlaezlp900, Bacteroides nlaezlp909, Bacteroides nlaezlp913, Bacteroides nlaezlp916, Bacteroides nlaezlp920, Bacteroides nlaezlp96, Bacteroides nordii, Bacteroides oleiciplenus, Bacteroides ovatus, Bacteroides paurosaccharolyticus, Bacteroides plebeius, Bacteroides R6, Bacteroides rodentium, Bacteroides S-17, Bacteroides S-18, Bacteroides salyersiae, Bacteroides SLC1-38, Bacteroides Smarlab, Bacteroides Smarlab, Bacteroides stercorirosoris, Bacteroides stercoris, Bacteroides str, Bacteroides thetaiotaomicron, Bacteroides TP-5, Bacteroides, Bacteroides uniformis, Bacteroides vulgatus, Bacteroides WA1, Bacteroides WH2, Bacteroides WH302, Bacteroides WH305, Bacteroides XB12B, Bacteroides XB44A, Bacteroides X077B42, Bacteroides xylanisolvens, Barnesiella, Barnesiella intestinihominis, Barnesiella NSB 1, Barnesiella, Barnesiella viscericola, Bavariicoccus, Bavariicoccus, Bdellovibrio, Bdellovibrio oral, Bergeriella, Bergeriella, Bifidobacterium, Bifidobacterium 103, Bifidobacterium 108, Bifidobacterium 113, Bifidobacterium 120, Bifidobacterium 138, Bifidobacterium 33, Bifidobacterium Acbbto5, Bifidobacterium adolescentis, Bifidobacterium Amsbbt12, Bifidobacterium angulatum, Bifidobacterium animalis, Bifidobacterium bacterium, Bifidobacterium bifidum, Bifidobacterium Bisn6, Bifidobacterium Bma6, Bifidobacterium breve, Bifidobacterium catenulatum, Bifidobacterium choerinum, Bifidobacterium coryneforme, Bifidobacterium dentium, Bifidobacterium DJF_WC44, Bifidobacterium F-10, Bifidobacterium F-11, Bifidobacterium group, Bifidobacterium h12, Bifidobacterium HMLN1, Bifidobacterium HMLN12, Bifidobacterium HMLN5, Bifidobacterium iarfr2341d, Bifidobacterium iarfr642d48, Bifidobacterium ic1332, Bifidobacterium indicum, Bifidobacterium kashiwanohense, Bifidobacterium LISLUCIII-2, Bifidobacterium longum, Bifidobacterium M45, Bifidobacterium merycicum, Bifidobacterium minimum, Bifidobacterium MSX5B, Bifidobacterium oral, Bifidobacterium PG12A, Bifidobacterium PL1, Bifidobacterium pseudocatenulatum, Bifidobacterium pseudolongum, Bifidobacterium pullorum, Bifidobacterium ruminantium, Bifidobacterium S-10, Bifidobacterium saeculare, Bifidobacterium saguini, Bifidobacterium scardovii, Bifidobacterium simiae, Bifidobacterium SLPYG-1, Bifidobacterium stellenboschense, Bifidobacterium stercoris, Bifidobacterium TM-7, Bifidobacterium Trm9, Bifidobacterium, Bilophila, Bilophila nlaezlh528, Bilophila, Bilophila wadsworthia, Blautia, Blautia bacterium, Blautia CE2, Blautia CE6, Blautia coccoides, Blautia DJF VR52, Blautia DJF_VR67, Blautia DJF_VR70k1, Blautia formate, Blautia glucerasea, Blautia hansenii, Blautia ic1272, Blautia 1E5, Blautia K-1, Blautia luti, Blautia M-1, Blautia mpnisolate, Blautia nlaezlc25, Blautia nlaezlc259, Blautia nlaezlc51, Blautia nlaezlc520, Blautia nlaezlc542, Blautia nlaezlc544, Blautia nlaezlh27, Blautia nlaezlh316, Blautia nlaezlh317, Blautia obeum, Blautia producta, Blautia productus, Blautia schinkii, Blautia Ser5, Blautia Ser8, Blautia, Blautia WAL, Blautia wexlerae, Blautia YHC-4, Brenneria, Brenneria, Brevibacterium, Brevibacterium, Brochothrix, Brochothrix thermosphacta, Buttiauxella, Buttiauxella 57916, Buttiauxella gaviniae, Butyricicoccus, Butyricicoccus bacterium, Butyricicoccus, Butyricimonas, Butyricimonas 180-3, Butyricimonas 214-4, Butyricimonas bacterium, Butyricimonas GD2, Butyricimonas synergistica, Butyricimonas, Butyricimonas virosa, Butyrivibrio, Butyrivibrio fibrisolvens, Butyrivibrio hungatei, Butyrivibrio, Caldimicrobium, Caldimicrobium, Caldisericum, Caldisericum, Campylobacter, Campylobacter coli, Campylobacter hominis, Campylobacter, Capnocytophaga, Capnocytophaga, Carnobacterium, Carnobacterium alterfunditum, Carnobacterium, Caryophanon, Caryophanon, Catenibacterium, Catenibacterium mitsuokai, Catenibacterium, Catonella, Catonella, Caulobacter, Caulobacter, Cellulophaga, Cellulophaga, Cellulosilyticum, Cellulosilyticum, Cetobacterium, Cetobacterium, Chelatococcus, Chelatococcus, Chlorobium, Chlorobium, Chryseobacterium, Chryseobacterium A1005, Chryseobacterium KJ9C8, Chryseobacterium, Citrobacter, Citrobacter 1, Citrobacter agglomerans, Citrobacter amalonaticus, Citrobacter ascorbata, Citrobacter bacterium, Citrobacter BinzhouCLT, Citrobacter braakii, Citrobacter enrichment, Citrobacter F24, Citrobacter F96, Citrobacter farmeri, Citrobacter freundii, Citrobacter gillenii, Citrobacter HBKC SR1, Citrobacter HD4.9, Citrobacter hormaechei, Citrobacter 191-3, Citrobacter ka55, Citrobacter lapagei, Citrobacter LAR-1, Citrobacter ludwigii, Citrobacter MEBS, Citrobacter MS36, Citrobacter murliniae, Citrobacter nlaezlc269, Citrobacter P014, Citrobacter P042bN, Citrobacter P046a, Citrobacter P073, Citrobacter SR3, Citrobacter T1, Citrobacter tnt4, Citrobacter tnt5, Citrobacter trout, Citrobacter TSA-1, Citrobacter, Citrobacter werkmanii, Cloacibacillus, Cloacibacillus adv66, Cloacibacillus nlaezlp702, Cloacibacillus NML05A017, Cloacibacillus, Cloacibacterium, Cloacibacterium, Collinsella, Collinsella A-1, Collinsella aerofaciens, Collinsella AUH-Julong21, Collinsella bacterium, Collinsella CCUG, Collinsella, Comamonas, Comamonas straminea, Comamonas testosteroni, Conexibacter, Conexibacter, Coprobacillus, Coprobacillus bacterium, Coprobacillus cateniformis, Coprobacillus TM-40, Coprobacillus, Coprococcus, Coprococcus 14505, Coprococcus bacterium, Coprococcus catus, Coprococcus comes, Coprococcus eutactus, Coprococcus nexile, Coprococcus, Coraliomargarita, Coraliomargarita fucoidanolyticus, Coraliomargarita marisflavi, Coraliomargarita, Corynebacterium, Corynebacterium amyocolatum, Corynebacterium durum, Coxiella, Coxiella, Cronobacter, Cronobacter dublinensis, Cronobacter sakazakii, Cronobacter turicensis, Cryptobacterium, Cryptobacterium curtum, Cupriavidus, Cupriavidus eutropha, Dechloromonas, Dechloromonas, HZ, Desulfobacterium, Desulfobacterium, Desulfobulbus, Desulfobulbus, Desulfopila, Desulfopila La4.1, Desulfovibrio, Desulfovibrio D4, Desulfovibrio desulfuricans, Desulfovibrio DSM12803, Desulfovibrio enrichment, Desulfovibrio fairfieldensis, Desulfovibrio LNB1, Desulfovibrio piger, Desulfovibrio, Dialister, Dialister E2-20, Dialister GBA27, Dialister invisus, Dialister oral, Dialister succinatiphilus, Dialister, Dorea, Dorea auhjulong64, Dorea bacterium, Dorea formicigenerans, Dorea longicatena, Dorea mpnisolate, Dorea, Dysgonomonas, Dysgonomonas gadei, Dysgonomonas, Edwardsiella, Edwardsiella tarda, Eggerthella, Eggerthella El, Eggerthella lenta, Eggerthella MLGO43, Eggerthella MVA1, Eggerthella S6-C1, Eggerthella SDG-2, Eggerthella sinensis, Eggerthella str, Eggerthella, Enhydrobacter, Enhydrobacter, Enterobacter, Enterobacter 1050, Enterobacter 1122, Enterobacter 77000, Enterobacter 82353, Enterobacter 9C, Enterobacter ASC, Enterobacter adecarboxylata, Enterobacter aerogenes, Enterobacter agglomerans, Enterobacter AJAR A2, Enterobacter amnigenus, Enterobacter asburiae, Enterobacter B1(2012), Enterobacter B363, Enterobacter B509, Enterobacter bacterium, Enterobacter Badong3, Enterobacter BEC441, Enterobacter C8, Enterobacter cancerogenus, Enterobacter cloacae, Enterobacter CO, Enterobacter core2, Enterobacter cowanii, Enterobacter dc6, Enterobacter DRSBII, Enterobacter enrichment, Enterobacter FL13-2-1, Enterobacter GIST-NKst10, Enterobacter GIST-NKst9, Enterobacter Enterobacter gx-148, Enterobacter hormaechei, Enterobacter I-Bh20-21, Enterobacter ICB 113, Enterobacter kobei, Enterobacter KW 14, Enterobacter 112, Enterobacter ludwigii, Enterobacter M10-1B, Enterobacter M1R3, Enterobacter marine, Enterobacter NCCP-167, Enterobacter of Enterobacter oryzae, Enterobacter oxytoca, Enterobacter P101, Enterobacter S11, Enterobacter SEL2, Enterobacter SPh, Enterobacter SSASP5, Enterobacter terrigena, Enterobacter TNT3, Enterobacter TP2MC, Enterobacter TS4, Enterobacter TSSAS2-48, i Enterobacter, Enterobacter ZYXCA1, Enterococcus, Enterococcus 020824/02-A, Enterococcus 1275b, Enterococcus 16C, Enterococcus 48, Enterococcus 6114, Enterococcus ABRII1VW-H61, Enterococcus asini, Enterococcus avium, Enterococcus azikeevi, Enterococcus bacterium, Enterococcus BBDP57, Enterococcus BPH34, Enterococcus Bt, Enterococcus canis, Enterococcus casseliflavus, Enterococcus CmNA2, Enterococcus Da-20, Enterococcus devriesei, Enterococcus dispar, Enterococcus DJF_O30, Enterococcus DMB4, Enterococcus durans, Enterococcus enrichment, Enterococcus F81, Enterococcus faecalis, Enterococcus faecium, Enterococcus fcc9, Enterococcus fecal, Enterococcus flavescens, Enterococcus fluvialis, Enterococcus FR-3, Enterococcus FUA3374, Enterococcus gallinarum, Enterococcus GHAPRB1, Enterococcus GSC-2, Enterococcus GYPB01, Enterococcus hermanniensis, Enterococcus hirae, Enterococcus lactis, Enterococcus malodoratus, Enterococcus manure, Enterococcus marine, Enterococcus MNC1, Enterococcus moraviensis, Enterococcus MS2, Enterococcus mundtii, Enterococcus NAB 15, Enterococcus NBRC, Enterococcus nlaezlc434, Enterococcus nlaezlg106, Enterococcus nlaezlg87, Enterococcus nlaezlh339, Enterococcus nlaezlh375, Enterococcus nlaezlh381, Enterococcus nlaezlh383, Enterococcus nlaezlh405, Enterococcus nlaezlp116, Enterococcus nlaezlp148, Enterococcus nlaezlp401, Enterococcus nlaezlp650, Enterococcus pseudoavium, Enterococcus R-25205, Enterococcus raffinosus, Enterococcus rottae, Enterococcus RU07, Enterococcus saccharolyticus, Enterococcus saccharominimus, Enterococcus sanguinicola, Enterococcus SCA16, Enterococcus SCA2, Enterococcus SE138, Enterococcus SF-1, Enterococcus sulfureus, Enterococcus ST76, Enterococcus tela, Enterococcus te32a, Enterococcus te42a, Enterococcus te45r, Enterococcus te49a, Enterococcus te51a, Enterococcus te58r, Enterococcus te59r, Enterococcus te61r, Enterococcus te93r, Enterococcus te95a, Enterococcus, Enterorhabdus, Enterorhabdus caecimuris, Enterorhabdus, Enwinia, Enwinia agglomerans, Enwinia enterica, Enwinia rhapontici, Enwinia tasmaniensis, Enwinia, Erysipelotrichaceae_incertae_sedis, Erysipelotrichaceae_incertae_sedis aff, Erysipelotrichaceae_incertae_sedis bacterium, Erysipelotrichaceae_incertae_sedis biforme, Erysipelotrichaceae_incertae_sedis C-1, Erysipelotrichaceae_incertae_sedis cylindroides, Erysipelotrichaceae_incertae_sedis GK12, Erysipelotrichaceae_incertae_sedis innocuum, Erysipelotrichaceae_incertae_sedis nlaezlc332, Erysipelotrichaceae_incertae_sedis nlaezlc340, Erysipelotrichaceae_incertae_sedis nlaezlg420, Erysipelotrichaceae_incertae_sedis nlaezlg425, Erysipelotrichaceae_incertae_sedis nlaezlg440, Erysipelotrichaceae_incertae_sedis nlaezlg463, Erysipelotrichaceae_incertae_sedis nlaezlh340, Erysipelotrichaceae_incertae_sedis nlaezlh354, Erysipelotrichaceae_incertae_sedis nlaezlh379, Erysipelotrichaceae_incertae_sedis nlaezlh380, Erysipelotrichaceae_incertae_sedis nlaezlh385, Erysipelotrichaceae_incertae_sedis nlaezlh410, Erysipelotrichaceae_incertae_sedis tortuosum, Erysipelotrichaceae_incertae_sedis, Escherichia/Shigella, Escherichia/Shigella 29(2010), Escherichia/Shigella 4091, Escherichia/Shigella 4104, Escherichia/Shigella 8gw18, Escherichia/Shigella A94, Escherichia/Shigella albertii, Escherichia/Shigella B-1012, Escherichia/Shigella B4, Escherichia/Shigella bacterium, Escherichia/Shigella BBDP 15, Escherichia/Shigella BBDP80, Escherichia/Shigella boydii, Escherichia/Shigella carotovorum, Escherichia/Shigella CERAR, Escherichia/Shigella coli, Escherichia/Shigella DBC-1, Escherichia/Shigella dc262011, Escherichia/Shigella dysenteriae, Escherichia/Shigella enrichment, Escherichia/Shigella escherichia, Escherichia/Shigella fecal, Escherichia/Shigella fergusonii, Escherichia/Shigella flexneri, Escherichia/Shigella GDR05, Escherichia/Shigella GDR07, Escherichia/Shigella H7, Escherichia/Shigella marine, Escherichia/Shigella ML2-46, Escherichia/Shigella mpnisolate, Escherichia/Shigella NA, Escherichia/Shigella nlaezlg330, Escherichia/Shigella nlaezlg400, Escherichia/Shigella nlaezlg441, Escherichia/Shigella nlaezlg506, Escherichia/Shigella nlaezlh204, Escherichia/Shigella nlaezlh208, Escherichia/Shigella nlaezlh209, Escherichia/Shigella nlaezlh213, Escherichia/Shigella nlaezlh214, Escherichia/Shigella nlaezlh4, Escherichia/Shigella nlaezlh435, Escherichia/Shigella nlaezlh81, Escherichia/Shigella nlaezlp126, Escherichia/Shigella nlaezlp198, Escherichia/Shigella nlaezlp21, Escherichia/Shigella nlaezlp235, Escherichia/Shigella nlaezlp237, Escherichia/Shigella nlaezlp239, Escherichia/Shigella nlaezlp25, Escherichia/Shigella nlaezlp252, Escherichia/Shigella nlaezlp275, Escherichia/Shigella nlaezlp280, Escherichia/Shigella nlaezlp51, Escherichia/Shigella nlaezlp53, Escherichia/Shigella nlaezlp669, Escherichia/Shigella nlaezlp676, Escherichia/Shigella nlaezlp717, Escherichia/Shigella nlaezlp731, Escherichia/Shigella nlaezlp826, Escherichia/Shigella nlaezlp877, Escherichia/Shigella nlaezlp884, Escherichia/Shigella NMU-ST2, Escherichia/Shigella oc182011, Escherichia/Shigella of Escherichia/Shigella proteobacterium, Escherichia/Shigella Q1, Escherichia/Shigella sakazakii, Escherichia/Shigella SF6, Escherichia/Shigella sm1719, Escherichia/Shigella SOD-7317, Escherichia/Shigella sonnei, Escherichia/Shigella SW86, Escherichia/Shigella, Escherichia/Shigella vulneris, Ethanoligenens, Ethanoligenens harbinense, Ethanoligenens, Eubacterium, Eubacterium ARC-2, Eubacterium callanderi, Eubacterium E-1, Eubacterium G3(2011), Eubacterium infirmum, Eubacterium limosum, Eubacterium methylotrophicum, Eubacterium nlaezlp439, Eubacterium nlaezlp457, Eubacterium nlaezlp458, Eubacterium nlaezlp469, Eubacterium nlaezlp474, Eubacterium oral, Eubacterium saphenum, Eubacterium sulci, Eubacterium, Eubacterium WAL, Euglenida, Euglenida longa, Faecalibacterium, Faecalibacterium bacterium, Faecalibacterium canine, Faecalibacterium DJF_VR20, Faecalibacterium ic1379, Faecalibacterium prausnitzii, Faecalibacterium, Filibacter, Filibacter globispora, Flavobacterium, Flavobacterium SSL03, Flavobacterium, Flavonifractor, Flavonifractor AUH-JLC235, Flavonifractor enrichment, Flavonifractor nlaezlc354, Flavonifractor orbiscindens, Flavonifractor plautii, Flavonifractor, Francisella, Francisella piscicida, Fusobacterium, Fusobacterium nucleatum, Fusobacterium, Gardnerella, Gardnerella, Gardnerella vaginalis, Gemmiger, Gemmiger DJF VR33k2, Gemmiger formicilis, Gemmiger, Geobacter, Geobacter, Gordonibacter, Gordonibacter bacterium, Gordonibacter intestinal, Gordonibacter pamelaeae, Gordonibacter, Gp2, Gp2, Gp21, Gp21, Gp4, Gp4, Gp6, Gp6, Granulicatella, Granulicatella adiacens, Granulicatella enrichment, Granulicatella oral, Granulicatella paraadiacens, Granulicatella, Haemophilus, Haemophilus, Hafnia, Hafnia 3-12(2010), Hafnia alvei, Hafnia CC16, Hafnia proteus, Hafnia, Haliea, Haliea, Hallella, Hallella seregens, Hallella, Herbaspirillum, Herbaspirillum 022S4-11, Herbaspirillum seropedicae, Hespellia, Hespellia porcina, Hespellia stercorisuis, Hespellia, Holdemania, Holdemania AP2, Holdemania filiformis, Holdemania, Howardella, Howardella, Howardella ureilytica, Hydrogenoanaerobacterium, Hydrogenoanaerobacterium saccharovorans, Hydrogenophaga, Hydrogenophaga bacterium, Ilumatobacter, Ilumatobacter, Janthinobacterium, Janthinobacterium C30An7, Janthinobacterium, Jeotgalicoccus, Jeotgalicoccus, Klebsiella, Klebsiella aerogenes, Klebsiella bacterium, Klebsiella E1L1, Klebsiella EB2-THQ, Klebsiella enrichment, Klebsiella F83, Klebsiella G1-6, Klebsiella gg160e, Klebsiella granulomatis, Klebsiella HaNA20, Klebsiella HF2, Klebsiella ii-3 chl-1, Klebsiella KALAICIBA17, Klebsiella kpu, Klebsiella M3, Klebsiella MB45, Klebsiella milletis, Klebsiella NCCP-138, Klebsiella okl-1-9 S16, Klebsiella okl-1-9 S54, Klebsiella planticola, Klebsiella pneumoniae, Klebsiella poinarii, Klebsiella PSB26, Klebsiella RS, Klebsiella Se14, Klebsiella SRC_DSD 12, Klebsiella td153s, Klebsiella TG-1, Klebsiella TPS5, Klebsiella, Klebsiella variicola, Klebsiella WB-2, Klebsiella Y9, Klebsiella zlmy, Kluyvera, Kluyvera An5-1, Kluyvera cryocrescens, Kluyvera, Kocuria, Kocuria 2216.35.31, Kurthia, Kurthia, Lachnobacterium, Lachnobacterium C12b, Lachnobacterium, Lachnospiracea_incertae_sedis, Lachnospiracea_incertae_sedis bacterium, Lachnospiracea_incertae_sedis contortum, Lachnospiracea_incertae_sedis Eg2, Lachnospiracea_incertae_sedis eligens, Lachnospiracea_incertae_sedis ethanolgignens, Lachnospiracea_incertae_sedis galacturonicus, Lachnospiracea_incertae_sedis gnavus, Lachnospiracea_incertae_sedis hallii, Lachnospiracea_incertae_sedis hydrogenotrophica, Lachnospiracea_incertae_sedis IDS, Lachnospiracea_incertae_sedis intestinal, Lachnospiracea_incertae_sedis mpnisolate, Lachnospiracea_incertae_sedis pectinoschiza, Lachnospiracea_incertae_sedis ramulus, Lachnospiracea_incertae_sedis rectale, Lachnospiracea_incertae_sedis RLB1, Lachnospiracea_incertae_sedis rumen, Lachnospiracea_incertae_sedis SY8519, Lachnospiracea_incertae_sedis torques, Lachnospiracea_incertae_sedis, Lachnospiracea_incertae_sedis uniforme, Lachnospiracea_incertae_sedis ventriosum, Lachnospiracea_incertae_sedis xylanophilum, Lachnospiracea_incertae_sedis ye62, Lactobacillus, Lactobacillus 5-1-2, Lactobacillus 66c, Lactobacillus acidophilus, Lactobacillus arizonensis, Lactobacillus B5406, Lactobacillus brevis, Lactobacillus casei, Lactobacillus crispatus, Lactobacillus curvatus, Lactobacillus delbrueckii, Lactobacillus fermentum, Lactobacillus gasseri, Lactobacillus helveticus, Lactobacillus hominis, Lactobacillus ID9203, Lactobacillus IDSAc, Lactobacillus intestinal, Lactobacillus johnsonii, Lactobacillus lactis, Lactobacillus manihotivorans, Lactobacillus mucosae, Lactobacillus NA, Lactobacillus oris, Lactobacillus P23, Lactobacillus P8, Lactobacillus paracasei, Lactobacillus paraplantarum, Lactobacillus pentosus, Lactobacillus plantarum, Lactobacillus pontis, Lactobacillus rennanqil fi; 10, Lactobacillus rennanqil fi; 14, Lactobacillus rennanqilyf9, Lactobacillus reuteri, Lactobacillus rhamnosus, Lactobacillus salivarius, Lactobacillus sanfranciscensis, Lactobacillus suntoryeus, Lactobacillus T3R1C1, Lactobacillus, Lactobacillus vaginalis, Lactobacillus zeae, Lactococcus, Lactococcus 56, Lactococcus CR-317S, Lactococcus CW-1, Lactococcus D8, Lactococcus Da-18, Lactococcus DAP39, Lactococcus delbrueckii, Lactococcus F116, Lactococcus fujiensis, Lactococcus G22, Lactococcus garvieae, Lactococcus lactis, Lactococcus manure, Lactococcus RTS, Lactococcus SXVIII1(2011), Lactococcus TP2MJ, Lactococcus TP2ML, Lactococcus TP2MN, Lactococcus U5-1, Lactococcus, Lactonifactor, Lactonifactor bacterium, Lactonifactor longoviformis, Lactonifactor nlaezlc533, Lactonifactor, Leclercia, Leclercia, Lentisphaera, Lentisphaera, Leuconostoc, Leuconostoc carnosum, Leuconostoc citreum, Leuconostoc garlicum, Leuconostoc gasicomitatum, Leuconostoc gelidum, Leuconostoc inhae, Leuconostoc lactis, Leuconostoc MEBE2, Leuconostoc mesenteroides, Leuconostoc pseudomesenteroides, Leuconostoc, Limnobacter, Limnobacter spf3, Luteolibacter, Luteolibacter bacterium, Lutispora, Lutispora, Marinifilum, Marinifilum, Marinobacter, Marinobacter arcticus, Mariprofundus, Mariprofundus, Marvinbryantia, Marvinbryantia, Megamonas, Megamonas, Megasphaera, Megasphaera, Melissococcus, Melissococcus faecalis, Methanobacterium, Methanobacterium subterraneum, Methanobrevibacter, Methanobrevibacter arboriphilus, Methanobrevibacter millerae, Methanobrevibacter olleyae, Methanobrevibacter oralis, Methanobrevibacter SM9, Methanobrevibacter smithii, Methanobrevibacter, Methanosphaera, Methanosphaera stadtmanae, Methanosphaera, Methylobacterium, Methylobacterium adhaesivum, Methylobacterium bacterium, Methylobacterium iEII3, Methylobacterium MP3, Methylobacterium oryzae, Methylobacterium PB132, Methylobacterium PB20, Methylobacterium PB280, Methylobacterium PDD-23b-14, Methylobacterium radiotolerans, Methylobacterium Methylobacterium, Mitsuokella, Mitsuokella jalaludinii, Mitsuokella, Morganella, Morganella morganii, Morganella, Moritella, Moritella 2D2, Moryella, Moryella indoligenes, Moryella naviforme, Moryella, Mycobacterium, Mycobacterium tuberculosis, Mycobacterium, Negativicoccus, Negativicoccus, Nitrosomonas, Nitrosomonas eutropha, Novosphingobium, Novosphingobium, Odoribacter, Odoribacter laneus, Odoribacter splanchnicus, Odoribacter, Olsenella, Olsenella 1832, Olsenella F0206, Olsenella, Orbus, Orbus gilliamella, Oribacterium, Oribacterium, Oscillibacter, Oscillibacter bacterium, Oscillibacter enrichment, Oscillibacter, Owenweeksia, Owenweeksia, Oxalobacter, Oxalobacter formigenes, Oxalobacter, Paludibacter, Paludibacter, Pantoea, Pantoea agglomerans, Pantoea eucalypti, Pantoea, Papillibacter, Papillibacter cinnamivorans, Papillibacter, Parabacteroides, Parabacteroides ASF519, Parabacteroides CR-34, Parabacteroides distasonis, Parabacteroides DIF B084, Parabacteroides DIF B086, Parabacteroides dnLKV8, Parabacteroides enrichment, Parabacteroides fecal, Parabacteroides goldsteinii, Parabacteroides gordonii, Parabacteroides johnsonii, Parabacteroides merdae, Parabacteroides mpnisolate, Parabacteroides nlaezlp340, Parabacteroides, Paraeggerthella, Paraeggerthella hongkongensis, Paraeggerthella nlaezlp797, Paraeggerthella nlaezlp896, Paraprevotella, Paraprevotella clara, Paraprevotella, Paraprevotella xylaniphila, Parasutterella, Parasutterella excrementihominis, Parasutterella, Pectobacterium, Pectobacterium carotovorum, Pectobacterium wasabiae, Pediococcus, Pediococcus te2r, Pediococcus, Pedobacter, Pedobacter b3N1b-b5, Pedobacter daechungensis, Pedobacter, Peptostreptococcus, Peptostreptococcus anaerobius, Peptostreptococcus stomatis, Peptostreptococcus, Phascolarctobacterium, Phascolarctobacterium faecium, Phascolarctobacterium, Photobacterium, Photobacterium MIE, Pilibacter, Pilibacter, Planctomyces, Planctomyces, Planococcaceae incertae sedis, Planococcaceae incertae sedis, Planomicrobium, Planomicrobium, Plesiomonas, Plesiomonas, Porphyrobacter, Porphyrobacter KK348, Porphyromonas, Porphyromonas asaccharolytica, Porphyromonas bennonis, Porphyromonas canine, Porphyromonas somerae, Porphyromonas, Prevotella, Prevotella bacterium, Prevotella BI-42, Prevotella bivia, Prevotella buccalis, Prevotella copri, Prevotella DIF B112, Prevotella mpnisolate, Prevotella oral, Prevotella, Propionibacterium, Propionibacterium acnes, Propionibacterium freudenreichii, Propionibacterium LG, Propionibacterium, Proteiniborus, Proteiniborus, Proteiniphilum, Proteiniphilum, Proteus, Proteus HS7514, Providencia, Providencia, Pseudobutyrivibrio, Pseudobutyrivibrio bacterium, Pseudobutyrivibrio fibrisolvens, Pseudobutyrivibrio ruminis, Pseudobutyrivibrio, Pseudochrobactrum, Pseudochrobactrum, Pseudoflavonifractor, Pseudoflavonifractor asf500, Pseudoflavonifractor bacterium, Pseudoflavonifractor capillosus, Pseudoflavonifractor NML, Pseudoflavonifractor, Pseudomonas, Pseudomonas 1043, Pseudomonas 10569, Pseudomonas 127(39-zx), Pseudomonas 12A-19, Pseudomonas 145(38zx), Pseudomonas 22010, Pseudomonas 32010, Pseudomonas 34t20, Pseudomonas 3C-10, Pseudomonas 4-5(2010), Pseudomonas 4-9(2010), Pseudomonas Pseudomonas 63596, Pseudomonas 82010, Pseudomonas a001-142L, Pseudomonas a101-18-2, Pseudomonas a111-5, Pseudomonas aeruginosa, Pseudomonas agarici, Pseudomonas amsp1, Pseudomonas AU2390, Pseudomonas AZ18R1, Pseudomonas azotoformans, Pseudomonas B122, Pseudomonas B65(2012), Pseudomonas bacterium, Pseudomonas BJSX, Pseudomonas BLH-8D5, Pseudomonas BWDY-29, Pseudomonas CA18, Pseudomonas Cantas12, Pseudomonas CB 11, Pseudomonas CBZ-4, Pseudomonas cedrina, Pseudomonas CGMCC, Pseudomonas CL16, Pseudomonas CNE, Pseudomonas corrugata, Pseudomonas cuatrocienegasensis, Pseudomonas CYEB-7, Pseudomonas D5, Pseudomonas DAP37, Pseudomonas DB48, Pseudomonas deceptionensis, Pseudomonas Den-05, Pseudomonas DF7EH1, Pseudomonas DhA-91, Pseudomonas DVS14a, Pseudomonas DYJK4-9, Pseudomonas DZQS, Pseudomonas E11_ICE19B, Pseudomonas E2.2, Pseudomonas e2-CDC-TB4D2, Pseudomonas EM189, Pseudomonas enrichment, Pseudomonas extremorientalis, Pseudomonas FAIR/BE/F/GH37, Pseudomonas FAIR/BE/F/GH39, Pseudomonas FAIR/BE/F/GH94, Pseudomonas FLM05-3, Pseudomonas fluorescens, Pseudomonas fragi, Pseudomonas TSL, Pseudomonas G1013, Pseudomonas gingeri, Pseudomonas HC2-2, Pseudomonas HC2-4, Pseudomonas HC2-5, Pseudomonas HC4-8, Pseudomonas HC6-6, Pseudomonas Hg4-06, Pseudomonas HLB8-2, Pseudomonas HLS12-1, Pseudomonas HSF20-13, Pseudomonas HW08, Pseudomonas 11-44, Pseudomonas IpA-92, Pseudomonas IV, Pseudomonas JCM, Pseudomonas jessenii, Pseudomonas JSPBS, Pseudomonas K3R3.1A, Pseudomonas KB40, Pseudomonas KB42, Pseudomonas KB44, Pseudomonas KB63, Pseudomonas KB73, Pseudomonas KK-21-4, Pseudomonas KOPRI, Pseudomonas L1R3.5, Pseudomonas LAB-27, Pseudomonas LAB-44, Pseudomonas Lc10-2, Pseudomonas libanensis, Pseudomonas Ln5C. 7, Pseudomonas LS197, Pseudomonas lundensis, Pseudomonas marginalis, Pseudomonas MFY 143, Pseudomonas MFY 146, Pseudomonas MY1404, Pseudomonas MY1412, Pseudomonas MY1416, Pseudomonas MY1420, Pseudomonas N14zhy, Pseudomonas NBRC, Pseudomonas NCCP-506, Pseudomonas NFU20-14, Pseudomonas NJ-22, Pseudomonas NJ-24, Pseudomonas Nj-3, Pseudomonas Nj-55, Pseudomonas Nj-56, Pseudomonas Nj-59, Pseudomonas Nj-60, Pseudomonas Nj-62, Pseudomonas Nj-70, Pseudomonas NP41, Pseudomonas OCW4, Pseudomonas OW3-15-3-2, Pseudomonas P1(2010), Pseudomonas P2(2010), Pseudomonas P3(2010), Pseudomonas P4(2010), Pseudomonas PD, Pseudomonas PF 1B4, Pseudomonas PF2M10, Pseudomonas PILH1, Pseudomonas poae, Pseudomonas proteobacterium, Pseudomonas ps4-12, Pseudomonas ps4-2, Pseudomonas xps4-28, Pseudomonas ps4-34, Pseudomonas ps4-4, Pseudomonas psychrophila, Pseudomonas putida, Pseudomonas R-35721, Pseudomonas R-37257, Pseudomonas R-37265, Pseudomonas R-37908, Pseudomonas RBE1CD-48, Pseudomonas RBE2CD-42, Pseudomonas regd9, Pseudomonas RKS7-3, Pseudomonas S2, Pseudomonas seawater, Pseudomonas SGb08, Pseudomonas SGb 120, Pseudomonas SGb396, Pseudomonas sgn, Pseudomonas ‘Shk, Pseudomonas stutzeri, Pseudomonas syringae, Pseudomonas taetrolens, Pseudomonas tolaasii, Pseudomonas trivialis, Pseudomonas TUT1023, Pseudomonas, Pseudomonas W15Feb26, Pseudomonas W15Feb4, Pseudomonas W 15Feb6, Pseudomonas WD-3, Pseudomonas WR4-13, Pseudomonas WR7 #2, Pseudomonas Y1000, Pseudomonas ZS29-8, Psychrobacter, Psychrobacter umb13d, Psychrobacter, Pyramidobacter, Pyramidobacter piscolens, Pyramidobacter, Rahnella, Rahnella aquatilis, Rahnella carotovorum, Rahnella GIST-WP4w1, Rahnella LR113, Rahnella, Rahnella Z2-S1, Ralstonia, Ralstonia bacterium, Ralstonia, Raoultella, Raoultella B 19, Raoultella enrichment, Raoultella planticola, Raoultella sv6xvii, Raoultella SZ015, Raoultella, Renibacterium, Renibacterium G20, Rhizobium, Rhizobium leguminosarum, Rhodococcus, Rhodococcus erythropolis, Rhodopirellula, Rhodopirellula, Riemerella, Riemerella anatipestifer, Rikenella, Rikenella, Robinsoniella, Robinsoniella peoriensis, Robinsoniella, Roseburia, Roseburia 11SE37, Roseburia bacterium, Roseburia cecicola, Roseburia DJF VR77, Roseburia faecis, Roseburia fibrisolvens, Roseburia hominis, Roseburia intestinalis, Roseburia inulinivorans, Roseburia, Roseibacillus, Roseibacillus, Rothia, Rothia, Rubritalea, Rubritalea, Ruminococcus, Ruminococcus 25F6, Ruminococcus albus, Ruminococcus bacterium, Ruminococcus bromii, Ruminococcus callidus, Ruminococcus champanellensis, Ruminococcus DJF VR87, Ruminococcus flavefaciens, Ruminococcus gauvreauii, Ruminococcus lactaris, Ruminococcus NK3A76, Ruminococcus, Ruminococcus YE71, Saccharofermentans, Saccharofermentans, Salinicoccus, Salinicoccus, Salinimicrobium, Salinimicrobium, Salmonella, Salmonella agglomerans, Salmonella bacterium, Salmonella enterica, Salmonella freundii, Salmonella hermannii, Salmonella paratyphi, Salmonella SL0604, Salmonella subterranea, Salmonella, Scardovia, Scardovia oral, Schwartzia, Schwartzia, Sedimenticola, Sedimenticola, Sediminibacter, Sediminibacter, Selenomonas, Selenomonas fecal, Selenomonas, Serpens, Serpens, Serratia, Serratia 1135, Serratia 136-2, Serratia 5.1R, Serratia AC-CS-1B, Serratia AC-CS-B2, Serratia aquatilis, Serratia bacterium, Serratia BS26, Serratia carotovorum, Serratia DAP6, Serratia enrichment, Serratia F2, Serratia ficaria, Serratia fonticola, Serratia grimesii, Serratia J145, Serratia JA4983, Serratia liquefaciens, Serratia marcescens, Serratia plymuthica, Serratia proteamaculans, Serratia proteolyticus, Serratia ptz-16s, Serratia quinivorans, Serratia SBS, Serratia SS22, Serratia trout, Serratia UA-G004, Serratia, Serratia White, Serratia yellow, Shewanella, Shewanella baltica, Shewanella, Slackia, Slackia intestinal, Slackia isoflavoniconvertens, Slackia NATTS, Slackia, Solibacillus, Solibacillus, Solobacterium, Solobacterium moorei, Solobacterium, Spartobacteria_genera_incertae_sedis, Spartobacteria_genera_incertae_sedis, Sphingobium, Sphingobium, Sphingomonas, Sphingomonas, Sporacetigenium, Sporacetigenium, Sporobacter, Sporobacter, Sporobacterium, Sporobacterium olearium, Staphylococcus, Staphylococcus epidermidis, Staphylococcus PCA17, Staphylococcus, Stenotrophomonas, Stenotrophomonas, Streptococcus, Streptococcus 1606-02B, Streptococcus agalactiae, Streptococcus alactolyticus, Streptococcus anginosus, Streptococcus bacterium, Streptococcus bovis, Streptococcus ChDC, Streptococcus constellatus, Streptococcus CR-3145, Streptococcus criceti, Streptococcus cristatus, Streptococcus downei, Streptococcus dysgalactiae, Streptococcus enrichment, Streptococcus equi, Streptococcus equinus, Streptococcus ES11, Streptococcus eubacterium, Streptococcus fecal, Streptococcus gallinaceus, Streptococcus gallolyticus, Streptococcus gastrococcus, Streptococcus genomosp, Streptococcus gordonii, Streptococcus 15, Streptococcus infantarius, Streptococcus intermedius, Streptococcus Je2, Streptococcus JS-CD2, Streptococcus LRC, Streptococcus luteciae, Streptococcus lutetiensis, Streptococcus M09-11185, Streptococcus mitis, Streptococcus mutans, Streptococcus NA, Streptococcus nlaezlc353, Streptococcus nlaezlp68, Streptococcus nlaezlp758, Streptococcus nlaezlp807, Streptococcus oral, Streptococcus oralis, Streptococcus parasanguinis, Streptococcus phocae, Streptococcus pneumoniae, Streptococcus porcinus, Streptococcus pyogenes, Streptococcus S 16-08, Streptococcus salivarius, Streptococcus sanguinis, Streptococcus sobrinus, Streptococcus suis, Streptococcus symbiont, Streptococcus thermophilus, Streptococcus TW1, Streptococcus, Streptococcus vestibularis, Streptococcus warneri, Streptococcus XJ-RY-3, Streptomyces, Streptomyces malaysiensis, Streptomyces MVCS6, Streptophyta, Streptophyta cordifolium, Streptophyta ginseng, Streptophyta hirsutum, Streptophyta oleracea, Streptophyta sativa, Streptophyta sativum, Streptophyta sativus, Streptophyta tabacum, Streptophyta, Subdivision3_genera_incertae_sedis, Subdivision3_genera_incertae_sedis, Subdoligranulum, Subdoligranulum bacterium, Subdoligranulum ic1393, Subdoligranulum ic1395, Subdoligranulum, Subdoligranulum variabile, Succiniclasticum, Succiniclasticum, Sulfuricella, Sulfuricella, Sulfurospirillum, Sulfurospirillum, Sutterella, Sutterella, Sutterella wadsworthensis, Syntrophococcus, Syntrophococcus, Syntrophomonas, Syntrophomonas bryantii, Syntrophomonas, Syntrophus, Syntrophus, Tannerella, Tannerella, Tatumella, Tatumella, Thermofilum, Thermofilum, Thermogymnomonas, Thermogymnomonas, Thermovirga, Thermovirga, Thiomonas, Thiomonas ML1-46, Thorsellia, Thorsellia carsonella, TM7 genera_incertae_sedis, TM7 genera_incertae_sedis, Trichococcus, Trichococcus, Turicibacter, Turicibacter sanguinis, Turicibacter, Vagococcus, Vagococcus bfsll-15, Vagococcus, Vampirovibrio, Vampirovibrio, Varibaculum, Varibaculum, Variovorax, Variovorax KS2D-23, Veillonella, Veillonella dispar, Veillonella MSA12, Veillonella OK8, Veillonella oral, Veillonella parvula, Veillonella tobetsuensis, Veillonella, Vibrio, Vibrio 3C1, Vibrio, Victivallis, Victivallis, Victivallis vadensis, Vitellibacter, Vitellibacter, Wandonia, Wandonia haliotis, Weissella, Weissella cibaria, Weissella confusa, Weissella oryzae, Weissella, Yersinia, Yersinia 9gw38, Yersinia A125, Yersinia aldovae, Yersinia aleksiciae, Yersinia b702011, Yersinia bacterium, Yersinia bercovieri, Yersinia enterocolitica, Yersinia entomophaga, Yersinia frederiksenii, Yersinia intermedia, Yersinia kristensenii, Yersinia MAC, Yersinia massiliensis, Yersinia mollaretii, Yersinia nurmii, Yersinia pekkanenii, Yersinia pestis, Yersinia pseudotuberculosis, Yersinia rohdei, Yersinia ruckeri, Yersinia s1Ofe31, Yersinia s17fe31, Yersinia s4fe31, Yersinia, Yersinia YEM17B.

Microbes are diverse, ubiquitous, and abundant, yet their population patterns and the factors driving these patterns were prior to the present inventions not readily understood in fermentation settings and thus it is believed never effectively used for the purposes for ascertaining predictive information. Microorganisms, just like macroorganisms (i.e., plants and animals), exhibit no single shared population pattern. The specific population patterns shown by microorganisms are variable and depend on a number of factors, including, the degree of phylogenetic resolution at which the communities are examined (e.g., Escherichia), the taxonomic group in question, the specific genes and metabolic capabilities that characterize the taxon, and the taxon's interactions with members of other taxa. Thus, such population patterns can be determined in fermentation settings and utilized as derived data for the purposes of ascertaining predictive information.

However, for certain environments, common patterns may emerge if the biogeography (e.g., microbial populations for example as determined from a census), of that particular environment is specifically examined. In particular, the structure and diversity of soil bacterial communities have been found to be closely related to soil environmental characteristics such as soil pH. A comprehensive assessment of the biogeographical patterns of, for example, soil bacterial communities requires 1) surveying individual communities at a reasonable level of phylogenetic detail (depth), and 2) examining a sufficiently large number of samples to assess spatial patterns (breadth). The studies of biogeographical patterns is not limited to soil, and will be extended to other environments, including but not limited to, any part of a living organisms, bodies of water, ice, the atmosphere, energy sources, factories, laboratories, farms, processing plants, hospitals, and other locations, systems and areas.

Generally, microbiome information may be contained in any type of data file that is utilized by current sequencing systems or that is a universal data format such as for example FASTQ (including quality scores), FASTA (omitting quality scores), GFF (for feature tables), etc. This data or files may then be combined using various software and computational techniques with identifiers or other data, examples of such software and identifiers for the combining of the various types of this information include the BIOM file format and the MI(x)S family of standards developed by the Genomic Standards Consortium. Additionally by way of example, in agricultural settings, data from a harvesting combine regarding yield, microbiome information, and commodities price information may be displayed or stored or used for further processing. The combination and communication of these various systems can be implemented by various data processing techniques, conversions of files, compression techniques, data transfer techniques, and other techniques for the efficient, accurate, combination, signal processing and overlay of large data streams and packets.

In general, real-time, historic, and combinations and variations of this microbiome information is analyzed to provide a census or population distribution of various microbes. Unlike conventional identification of a particular species that is present, the analysis of the present invention determines in an n-dimensional space (a mathematical construct having 2, 3, 5, 12, 1000, or more dimensions), the interrelationship of the various microbes present in the system, and potentially also interrelationship of their genes, transcripts, proteins and/or metabolites. The embodiments of the present invention provide further analysis to this n-dimensional space information, which analysis renders this information to a format which is more readily usable and processable and understandable. Thus, for example, by using the techniques of the present invention, the n-dimensional space information is analyzed and studied for patterns of significance pertinent to a particular fermentation setting and then converted to more readily usable data such as for example a 2-dimensional color-coded plot for presentation through a HMI (Human-Machine Interface).

Additionally, the n-dimensional space information may be related, e.g., transformed or correlated with, physical, environmental, or other data such as the conditions under which a particular plant was grown, either by projection into the same spatial coordinates or by relation of the coordinate systems themselves, or by feature extraction or other machine learning or multivariate statistical techniques. This related n-dimensional space information may then be further processed into a more readily usable format such as a 2-dimensional representation. Further, this 2-dimensional representation and processing may, for example, be based upon particular factors or features that are of significance in a particular fermentation setting. The 2-dimensional information may also be further viewed and analyzed for determining particular factors or features of significance for a system. Yet further, either of these types of 2-dimensional information may be still further processed using for example mathematical transformation functions to return them to an n-dimensional space which mathematical functions which may be based upon known or computationally determined factors or features.

In general, an embodiment may include one or more of the following steps which may be conducted in various orders: sample preparation including obtaining the sample at the designated location, and manipulating the sample; extraction of the genetic material and other biomolecules from the microbial communities in the sample; preparation of libraries with identifiers such as an appropriate barcode such as DNA libraries, metabolite libraries, and protein libraries of the material; sequence elucidation of the material (including, for example, DNA, RNA, and protein) of the microbial communities in the sample; processing and analysis of the sequencing and potentially other molecular data; and recognition of the microbial communities so that the end product can be optimized.

For example sampling may be for example from an agricultural, food, surfaces, water. The samples can include for example solid samples such as soil, sediment, rock, and food. The samples can include for example liquid samples such as surface water, and subsurface water, other liquid to be fermented or in a certain stage of fermentation, such as must, barrel fermented wine, yogurt, to name a few. The sample once obtained has the genetic material isolated or obtained from the sample, which for example can be DNA, RNA, proteins and fragments of these.

The accuracy of these analyses depends strongly on the choice of primers. Primers can be prepared by a variety of methods including, but not limited to, cloning of appropriate sequences and direct chemical synthesis or from commercial sources such as Integrated DNA Technologies, Operon Technologies, Amersham Pharmacia Biotech, Sigma, and Life Technologies. In addition, computer programs can also be used to design primers, including but not limited to Array Designer Software (Arrayit Inc.), Oligonucleotide Probe Sequence Design Software for Genetic Analysis (Olympus Optical Co.), NetPrimer, and DNAsis from Hitachi Software Engineering. Primers that can be used analyze the 16S ribosomal RNA gene include but are not limited to those described in the Examples below

Microbial diversity can be further described by approaches analyzing the intergenic region between 16S ribosomal RNA and 23S ribosomal RNA. Primers can be designed to specifically amplify any identified variable regions in a microbe or similar distinguishing genetic element. Primers or probes described herein can also include polynucleotides having at least 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 990, or 100% homology to any of the nucleic acid sequences described herein.

A library is prepared from the genetic material. In this stage of the process the library can be prepared by use of amplification, shotgun, whole molecule techniques among others. Additionally, amplification to add adapters for sequencing, and barcoding for sequences can be preformed. Shotgun by sonication, enzymatic cleavage may be performed. Whole molecules can also be used to sequence all DNA in a sample. Sequencing is performed. Preferably, the sequencing is with a high-throughput system, such as for example 454, Illumina, PacBio, or IonTorrent, Nanopore, to name a few.

Sequence analysis is prepared. This analysis preferably can be performed using tools such as QIIME Analysis Pipeline, Machine learning, and UniFrac. Preferably, there is assigned a sequence to the sample via barcode, for among other things quality control of sequence data.

The processing and analysis involves matching the sequences to the samples, aligning the sequences to each other, and using the aligned sequences to build a phylogenetic tree, and applying a deep learning neural network to identify patterns of the microbial communities in a particular sample over time and geographic space.

In one example Sample Collection: samples will be collected in a manner ensuring that microbes from the target source are the most numerous in the samples while minimizing the contamination of the sample by the storage container, sample collection device, the sample collector, other target or other non-target sources that may introduce microbes into the sample from the target source. Further, samples will be collected in a manner to ensure the target source is accurately represented by single or multiple samples at an appropriate depth (if applicable) to meet the needs of the microbiome analysis, or with known reference controls for possible sources of contamination that can be subtracted by computational analysis. Precautions should be taken to minimize sample degradation during shipping by using commercially available liquids, dry ice or other freezing methods for the duration of transit.

For example, samples can be collected in sterile, DNA/DNase/RNA/RNase-free primary containers with leak resistant caps or lids and placed in a second leak resistant vessel to limit any leakage during transport. Appropriate primary containers can include any plastic container with a tight fitting lid or cap that is suitable for work in microbiology or molecular biology considered to be sterile and free of microbial DNA (or have as little as possible) at minimum. (However, it should be noted that human DNA contamination, depending upon the markers or specific type microbe that is being looked at may not present a problem.) The primary container can also be comprised of metal, clay, earthenware, fabric, wood, etc. So long as the container may be sterilized and tested to ensure that it is ideally DNA/DNase/RNA/RNase-free (or at least contains levels of nucleic acid much lower than the biomass to be studied, and low enough concentration of nuclease that the nucleic acids collected are not degraded) and can be closed with a tight-fitting and leak resistant lid, cap or top, then it can be used as a primary container.

The primary container with the sample can then be placed into a secondary container, if appropriate. Appropriate secondary containers can include plastic screw top vessels with tight fitting lids or caps and plastic bags such as freezer-grade zip-top type bags. The secondary container can also be comprised of metal, clay, earthenware, fabric, wood, etc. So long as the container can be dosed or sealed with a tight-fitting and leak resistant lid, cap or top, then it can be used as a secondary container. The secondary container can also form a seal on itself or it can be fastened shut for leak resistance.

The samples should generally be collected with minimal contact between the target sample and the sample collector to minimize contamination. The sample collector, if human, should generally collect the target sample using gloves or other barrier methods to reduce contamination of the samples with microbes from the skin. The sample can also be collected with instruments that have been cleaned. The sample collector, if machine, should be cleaned and sterilized with UV light and/or by chemical means prior to each sample collection. If the machine sample collector requires any maintenance from a human or another machine, the machine sample collector must be additionally subjected to cleaning prior to collecting any samples.

After the sample is collected and placed in a primary and secondary container, the samples will be preserved. One method of preservation is by freezing on dry ice or liquid nitrogen to between 4° C. to −80° C. Another method of preservation is the addition of preservatives such as RNAstable™, LifeGuard™ or another commercial preservative, and following the respective instructions. So long as the preservation method will allow for the microbial nucleic acid to remain stable upon storage and upon later usage, then the method can be used.

The samples will be shipped in an expedient method to the testing facility. In another embodiment, the testing of the sample can be done on location. The sample testing should be performed within a time period before there is substantial degradation of the microbial material with in the sample. So long as the sample remains preserved and there is no substantial degradation of the microbial material, any method of transport in a reasonable period of time is sufficient.

Tracers will be added to the inflow of a sampling catchment to identify the organisms present in the system that are not from the target source. The tracer can be microorganisms or anything that will allow for analysis of the flow path. For example, in an oil setting, a tracer can be used to calibrate the effectiveness of a flooding operation (water, CO2, chemical, steam, etc.). The tracer will be used to determine factors such as the amount of injection fluid flowing through each zone at the production wellbore and the path of the injection fluid flow from the injection site to the production bore.

DNA/RNA Extraction is discussed next. The extraction of genetic material will be performed using methods with the ability to separate nucleic acids from other, unwanted cellular and sample matter in a way to make the genetic material suitable for library construction. For example, this can be done with methods including one or more of the following, but not limited to, mechanical disruption such as bead beating, sonicating, freezing and thawing cycles; chemical disruption by detergents, acids, bases, and enzymes; other organic or inorganic chemicals. Isolation of the genetic material can be done through methods including one or more of the following, but not limited to, binding and elution from silica matrices, washing and precipitation by organic or inorganic chemicals, electroelution or electrophoresis or other methods capable of isolating genetic material.

Extractions will be done in an environment suitable to exclude microbes residing in the air or on other surfaces in the work area where the extraction is taking place. Care will be taken to ensure that all work surfaces and instruments are cleaned to remove unwanted microbes, nucleases and genetic material. Cleaning work surfaces and instruments can include, but is not limited to, spraying and/or wiping surfaces with a chlorine bleach solution, commercially available liquids such as DNAse AWAY™ or RNase AWAY™ or similar substances that are acceptable in routine decontamination of molecular biology work areas. Furthermore, aerosol barrier pipette tips used in manual, semi-automated or automated extraction process will be used to limit transfer of genetic material between instruments and samples.

Controls for reagents for extractions and/or primary containers (when appropriate) will be tested to ensure they are free of genetic material. Testing of the reagents includes, but is not limited to performing extraction “blanks” where only the reagents are used in the extraction procedure. When necessary primary collection containers may also be tested for the presence of genetic material serving as a ‘negative control’ in PCR of the genetic material of the sample. In either case, testing the blank or negative control may be accomplished, but not limited to, spectrophotometric, fluorometric, electrophoretic, PCR or other assays capable of detecting genetic material, followed by testing the blank for the presence of genetic material by, but not limited to, spectrophotometric, fluorometric, electrophoretic, PCR or other assays capable of detecting genetic material.

Library Preparation allows identification of bacteria and fungi present in the sample. Different biomarkers are used for each kingdom, 16S for bacteria, ITS for fungi. In one improvement of building a library is the use of an additional single-copy marker gene allowing a more precise definition of bacterial strains in the sample.

Genetic material from the samples undergoes polymerase chain reaction (PCR) to amplify the gene of interest and encode each copy with barcode unique to the sample. Generally, PCR amplifies a single or a few copies of a piece of DNA across several orders of magnitude, generating thousands to millions, or more, of copies of a particular DNA sequence using a thermostable DNA polymerase. PCR will be used to amplify a portion of specific gene from the genome of the microbes present in the sample. Any method which can amplify genetic material quickly and accurately can be used for library preparation.

The PCR primer will be designed carefully to meet the goals of the sequencing method. The PCR primer will contain a length of nucleotides specific to the target gene, may contain an adapter that will allow the amplicon, also known as the PCR product, to bind and be sequenced on a high-throughput sequencing platform, and additional nucleotides to facilitate sequencing. The portion of the gene with adapters, barcode and necessary additional nucleotides is known as the “amplicon.” It being understood that future systems may not use, or need, adaptors. In one embodiment, forward and reverse primers as shown in the examples are used.

Sequence data can be analyzed in a manner in which sequences are identified and labeled as being from a specific sample using the unique barcode introduced during library preparation, if barcodes are used, or sample identifiers will be associated with each run directly if barcodes are not used. Once sequences have been identified as belonging to a specific sample, the relationship between each pair of samples will be determined based on the distance between the collection of microbes present in each sample. In particular, techniques that allow for the comparison of many microbial samples in terms of the phylogeny of the microbes that live in them (“phylogenetic techniques”) characterize many communities in an efficient and cost-effective fashion.

After DNA sequence data is obtained the bioinformatics stages begin. This includes barcode decoding, sequence quality control, “upstream” analysis steps (including clustering of closely related sequences and phylogenetic tree construction), and “downstream” diversity analyses, visualization, and statistics. All of these steps are currently facilitated by the Quantitative Insights Into Microbial Ecology (QIIME, www.qiime.org) open source software package, which is the most widely used software for the analysis of microbial community data generated on high-throughput sequencing platforms. QIIME was initially designed to support the analysis of marker gene sequence data, but is also generally applicable to “comparative-omics” data (including but not limited to metabolomics, metatranscriptomics, and comparative human genomics).

Sequence barcodes will be read to identify the source sample of each sequence, poor quality regions of sequence reads will be trimmed, and poor quality reads will be discarded. These steps will be combined for computational efficiency. The features included in quality filtering include whether the barcode will unambiguously be mapped to a sample barcode, per-base quality scores, and the number of ambiguous (N) base calls. The default settings for all quality control parameters in QIIME will be determined by benchmarking combinations of these parameters on artificial (i.e., “mock”) community data, where microbial communities were created in the lab from known concentrations of cultured microbes, and the composition of the communities is thus known in advance. After mapping sequence reads to samples and performing quality control, sequences will be clustered into OTUs (Operational Taxonomic Units). This is typically the most computationally expensive step in microbiome data analysis, and will be performed to reduce the computational complexity at subsequent steps. For shotgun metagenomic sequencing, the data obtained are random fragments of all genomic DNA present in a given microbiome. These can be compared to reference genomes to identify the types of organisms present in a manner similar to marker gene sequences, but they may also be used to infer biological functions encoded by the genomes of microbes in the community. Typically this is done by comparing them to reference genomes and/or individual genes or genetic fragments that have been annotated for functional content. In the case of shotgun metatranscriptomic sequencing, the data obtained are similar to that for shotgun metatranscroptomic sequencing except that the RNA rather than the DNA is used, and physical or chemical steps to deplete particular classes of sequence such as eukaryotic messenger RNA or ribosomal RNA are often used prior to library construction for sequencing. In the case of shotgun metaproteomics, protein fragments are obtained and matched to reference databases. In the case of shotgun metabolomics, metabolites are obtained by biophysical methods including nuclear magnetic resonance or mass spectrometry. In all of these cases, some type of coarse-graining of the original data equivalent to OTU picking to identify biologically relevant features is employed, and a biological observation matrix as described in relating either the raw or coarse-grained observations to samples is obtained. The steps downstream from the Biological Observation Matrix, including the construction of distance matrices, taxon or functional tables, and industry-specific, actionable models from such data, are conceptually equivalent for each of these datatypes and are within the scope of the present Invention.

The microbial communities present in each sample will be analyzed and compared. These analyses include, but are not limited to, summarizing the taxonomic composition of the samples, understanding the “richness” and “evenness” of samples (defined below), understanding the relative similarity of communities, and identifying organisms or groups of organisms that are significantly different across community types.

Taxonomic Composition of Samples can be studied at various taxonomic levels (e.g., phylum, class, species) by collapsing OTUs in the BIOM table based on their taxonomic assignments. Alpha diversity refers to diversity of single samples (i.e., within-sample diversity), including features such as taxonomic richness and evenness. The species richness is a measure of the number of different species of microbes in a given sample. Species evenness refers to how close in numbers the abundance of each species in an environment is. Measures of alpha diversity (or, within-sample diversity) have a long history in ecology. Alpha diversity scores have been shown to differ in different types of communities, for example, from different human body habitats. For instance, skin-surface bacterial communities have been found to be significantly more rich (i.e., containing more species) in females than in males, and at dry sites rather than sebaceous sites, and the gut microbiome of lean individuals have been found to be significantly more rich than those of obese individuals. One way of viewing alpha diversity in the context of environmental metadata, for example, the degree of phylogenetic diversity in a sample (a phylogeny-aware measure of richness) changes with soil pH, ranging from pH around 6.5 through 9.5, with a peak in richness around neutral pH of 7. In some cases alpha diversity will be useful input features for building predictive models via supervised classifiers.

Between-Sample Diversity (UniFrac and Principal Coordinates Analysis)

Generally the primary question of interest when beginning a survey of new microbial community types is the environmental features are associated with differences in the composition of microbial communities. Beta diversity metrics provide a measure of community dissimilarity, allowing investigators to determine the relative similarity of microbial communities. Metrics of beta diversity are pairwise, operating on two samples at a time. The difference in overall community composition between each pair of samples can be determined using the phylogenetically-aware UniFrac distance metric, which allows researchers to address many of these broader questions about the composition of microbial communities. UniFrac calculates the fraction of branch length unique to a sample across a phylogenetic tree constructed from each pair of samples. In other words, the UniFrac metric measures the distance between communities as the percentage of branch length that leads to descendants from only one of a pair of samples represented in a single phylogenetic tree, or the fraction of evolution that is unique to one of the microbial communities. Phylogenetic techniques for comparing microbial communities, such as UniFrac, avoid some of the pitfalls associated with comparing communities at only a single level of taxonomic resolution and provide a more robust index of community distances than traditional taxon-based methods, such as the Jaccard and Sorenson indices. Unlike phylogenetic techniques, species-based methods that measure the distance between communities based solely on the number of shared taxa do not consider the amount of evolutionary divergence between taxa, which can vary widely in diverse microbial populations. Among the first applications of phylogenetic information to comparisons of microbial communities were the Phylogenetic (P)-test and the Fst test. Pairwise significance tests are limited because they cannot be used to relate many samples simultaneously. Although phylogenetically-aware techniques such as UniFrac offer significant benefits, techniques lacking phylogenetic awareness can also be implemented with success: after an alternative distance metric (e.g. Bray-Curtis, Jensen-Shannon divergence) has been applied, the resulting inter-sample distance matrix is processed in the same way as a UniFrac distance matrix as described below.

A learning machine then identifies Features that are Predictive of Environment Characteristics (i.e., Sample Metadata). Supervised classification is a machine learning approach for developing predictive models from training data. Each training data point consists of a set of input features, for example, the relative abundance of taxa, and a qualitative dependent variable giving the correct classification of that data point. In microbiome analysis, such classifications might include soil nutrients, predominant weather patterns, disease states, therapeutic results, or forensic identification. The goal of supervised classification is to derive some function from the training data that can be used to assign the correct class or category labels to novel inputs (e.g. new samples), and to learn which features, for example, taxa, discriminate between classes. Common applications of supervised learning include text classification, microarray analysis, and other bioinformatics analyses. For example, when microbiologists use the Ribosomal Database Project website to classify 16S rRNA gene sequences taxonomically, a form of supervised classification is used.

Filters or wrappers can be used. Filter will be to identify features that are generally predictive of the response variable, or to remove features that are noisy or uninformative. Common filters include, but are not limited to, the between-class chi2 test, information gain (decrease in entropy when the feature is removed), various standard classification performance measures such as precision, recall, and the F-measure, and the accuracy of a univariate classifier, and the bi-normal separation (BNS), which treats the univariate true positive rate and the false-positive rate (tpr, fpr, based on document presence/absence in text classification) as though they were cumulative probabilities from the standard normal cumulative distribution function, and the difference between their respective z-scores, F1 (tpr)-F1 (fpr), will be used as a measure of that variable's relevance to the classification task.

A wrapper method, like a filter method, will treat the classifier as a black box, but instead of using a simple univariate or multivariate test to determine which features are important, a wrapper will use the classifier itself to evaluate subsets of features.

The present invention contemplates the application to a seed of a dry coating comprising a hydrogel, beneficial microbes, and active agents. The relative proportions of the hydrogel and active agents and the thickness of the coating are not critical to this concept and are within the discretion of the operator. However, it is recognized that the present invention affords certain advantages with respect to such considerations, including the ability achieve desired effects with lower amounts of active agents than employed in conventional treatments, and the ability to employ thinner coatings than the prior art high water content coatings. Therefore, the following discussion with respect to relative proportions and coating thicknesses is offered for general guidance, but should not be viewed as essential to an understanding of the present invention. The amount of active ingredient relative to the hydrogel depends on the concentration of active ingredient that is desired to be added to the seed and to be taken up into the plant, which in turn varies widely based on many factors, including the identity of the active ingredient, the type of seed/plant to be treated, the conditions of the growth medium and the watering conditions. As with conventional processes, the range of appropriate concentrations of active ingredient can be quite large. However, typical dosage rates under particular circumstances will be readily apparent to those of ordinary skill in the art based on the concentration of active ingredient conventionally desired about the seed, in the rhizosphere of the plant or within the plant under the circumstances, but recognizing that the increased uptake associated with employment of the technique of the present invention may allow use of a lower dosage rate of the active ingredient than used in the conventional method. It will be appreciated that the active ingredient dosage afforded by the present method depends not only on the concentration of the active ingredient in the coating, but also on the thickness of the coating applied to the seed. Of course, a minimum dosage rate is necessary for the active ingredient to affect the seed and/or plant, but because the dosage of the active ingredient is dependent on the combination of the concentration of the active ingredient in the coating as well as the total amount of coating present, a thick coating can compensate for a low active ingredient concentration. Moreover, it has been found that uptake increases with increasing levels of hydrogel. Therefore, the active ingredient concentration can be quite high, compensated for by a thin coating. In any event, however, because the hydrogel absorbs so much water, relatively little hydrogel is needed to produce a substantial effect. Thus, even though a very broad range of relative proportions of hydrogel to active ingredient that can be employed in the present invention and coordinated with a wide range of coating thicknesses, the proportion of active ingredient to hydrogel would typically be quite high even though the range of proportions would be quite broad. It is contemplated that even the preferred range of the active ingredient to hydrogel weight ratio may be anywhere from, say 100 to perhaps 10,000. Generally, however, relatively thin coatings are desired, especially of less than, say, about one millimeter, or even less than about 0.5 millimeters, and so active ingredient concentrations may be set accordingly. The coated seeds may be handled, transported, stored and distributed in the manner of uncoated seeds. Likewise, they may be sown and watered in the same manner as uncoated seeds as well, using conventional equipment. Typically, the present invention is applicable to crops to be grown in soil, although it may be applied to other plants and growing media without departing from the scope of the invention. It has been found that the seed treatment of the present invention can impart long-lasting desired effects of the active ingredient to the seed and resulting plant without need for re-treatment.

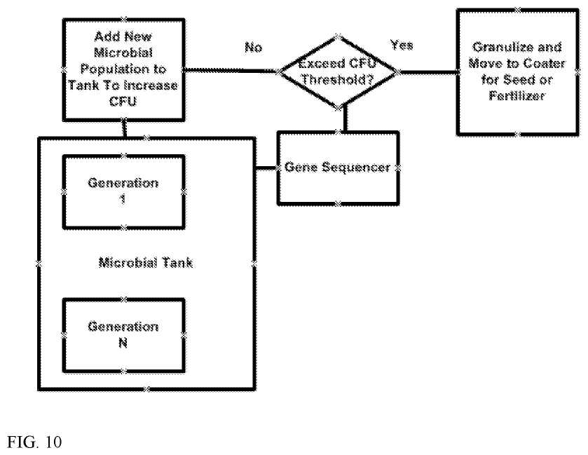

FIG. 10 shows an exemplary genetic guided microbial production system running in a closed loop. In this system a microbial tank is used to grow selected microbial populations. The microbes are selected for their properties/traits, which are identifiable through gene sequencing equipment. Once a target cluster of families of microbes and their population thresholds have been designed or specified, a starting population is provided into the grow tank along with nutrients such as sucrose and other input materials. The microbial population is grown and periodically sampled by DNA sequencers. If corrections are needed, additional feed input is provided to the growing tank to correct the microbial population into the desired microbiome. Once the desired microbiome is reached, the tank outputs the microbes, which can be suitably processed into dry form (or liquid form if desired). The microbes are then transferred to the coating machine and embedded with seeds, fertilizer, or any other soil amendment products. The method uses genetic testing to check on microbial population characteristics and iteratively growing the mixture with the predetermined microbial population characteristics as a closed feedback loop. Control theory is used to improve the stability, robustness and performance of microbial production systems. A closed loop feedback system involves a physical process to be controlled and a controller receiving genetic charactization data. In a classical negative feedback set-up, the controller reads the microbial population count y for each microbial family members of the population, compares it with a desired value u, and, based on the error between these two, computes the input to be applied to the process to ultimately decrease the discrepancy between y and u.

One embodiment to classify the microbiome uses a conditional-GAN (cGAN) as a deep learning machine. The cGAN consists of two major parts: generator G and discriminator D. The task of generator is to produce an image indistinguishable from a real image and “fool” the discriminator. The task of the discriminator is to distinguish between real image and fake image from the generator, given the reference input image.

The objective of a conditional-GAN is composed of two parts: adversarial loss and LI loss. The adversarial loss can be: [symbol] _{cGAN}(G,D)=E_{x,y}[log D(x,y)]Eₓ[log(1−D(x,Gx))] where L1 distance is added to generated image. L1 distance is preferred over L2 distance as it produces images with less blurring. Thus our full objective for the minimax game is:

$$( {G}^{*} , {D}^{*} ) = arg {min}_{G} {max}_{D} ( {ℒ}_{cGAN} ( G , D ) + {λℒ}_{LI} ( G ) )$$

The ResNet-50 network by He et al. can be used as the generator, while the discriminator can be a convolutional “PatchGAN” classifier with architecture similar to the classifier in pix2pix as our discriminator.

In addition to cGAN, other neural networks can be used. FIGS. 2B-2J show exemplary alternatives, including:

1. AlexNet—AlexNet is the first deep architecture which can be introduced by one of the pioneers in deep learning—Geoffrey Hinton and his colleagues. It is a simple yet powerful network architecture, which helped pave the way for groundbreaking research in Deep Learning as it is now.

2. VGG Net—The VGG Network can be introduced by the researchers at Visual Graphics Group at Oxford (hence the name VGG). This network is specially characterized by its pyramidal shape, where the bottom layers which are closer to the image are wide, whereas the top layers are deep. VGG contains subsequent convolutional layers followed by pooling layers. The pooling layers are responsible for making the layers narrower. In their paper, they proposed multiple such types of networks, with change in deepness of the architecture.

3. GoogleNet—In this architecture, along with going deeper (it contains 22 layers in comparison to VGG which had 19 layers), the Inception module is used. In a single layer, multiple types of “feature extractors” are present. This indirectly helps the network perform better, as the network at training itself has many options to choose from when solving the task. It can either choose to convolve the input, or to pool it directly. The final architecture contains multiple of these inception modules stacked one over the other. Even the training is slightly different in GoogleNet, as most of the topmost layers have their own output layer. This nuance helps the model converge faster, as there is a joint training as well as parallel training for the layers itself.

4. ResNet—ResNet is one of the monster architectures which truly define how deep a deep learning architecture can be. Residual Networks (ResNet in short) consists of multiple subsequent residual modules, which are the basic building block of ResNet architecture. ResNet uses of standard SGD instead of a fancy adaptive learning technique. This is done along with a reasonable initialization function which keeps the training intact; Changes in preprocessing the input, where the input is first divided into patches and then feeded into the network. The main advantage of ResNet is that hundreds, even thousands of these residual layers can be used to create a network and then trained. This is a bit different from usual sequential networks, where you see that there is reduced performance upgrades as you increase the number of layers.

5. ResNeXt—ResNeXt is said to be the current state-of-the-art technique for object recognition. It builds upon the concepts of inception and resnet to bring about a new and improved architecture.

6. RCNN (Region Based CNN)—Region Based CNN architecture is said to be the most influential of all the deep learning architectures that have been applied to object detection problem. To solve detection problem, what RCNN does is to attempt to draw a bounding box over all the objects present in the image, and then recognize what object is in the image.

7. YOLO (You Only Look Once)—YOLO is a real time system built on deep learning for solving image detection problems. As seen in the below given image, it first divides the image into defined bounding boxes, and then runs a recognition algorithm in parallel for all of these boxes to identify which object class do they belong to. After identifying this classes, it goes on to merging these boxes intelligently to form an optimal bounding box around the objects. All of this is done in parallely, so it can run in real time; processing upto 40 images in a second.

8. SqueezeNet—The squeezeNet architecture is one more powerful architecture which is extremely useful in low bandwidth scenarios like mobile platforms. This architecture has occupies only 4.9 MB of space, on the other hand, inception occupies ˜100 MB! This drastic change is brought up by a specialized structure called the fire module which is good for mobile phone.

9. SegNet—SegNet is a deep learning architecture applied to solve image segmentation problem. It consists of sequence of processing layers (encoders) followed by a corresponding set of decoders for a pixelwise classification. Below image summarizes the working of SegNet. One key feature of SegNet is that it retains high frequency details in segmented image as the pooling indices of encoder network is connected to pooling indices of decoder networks. In short, the information transfer is direct instead of convolving them. SegNet is one the the best model to use when dealing with image segmentation problems.

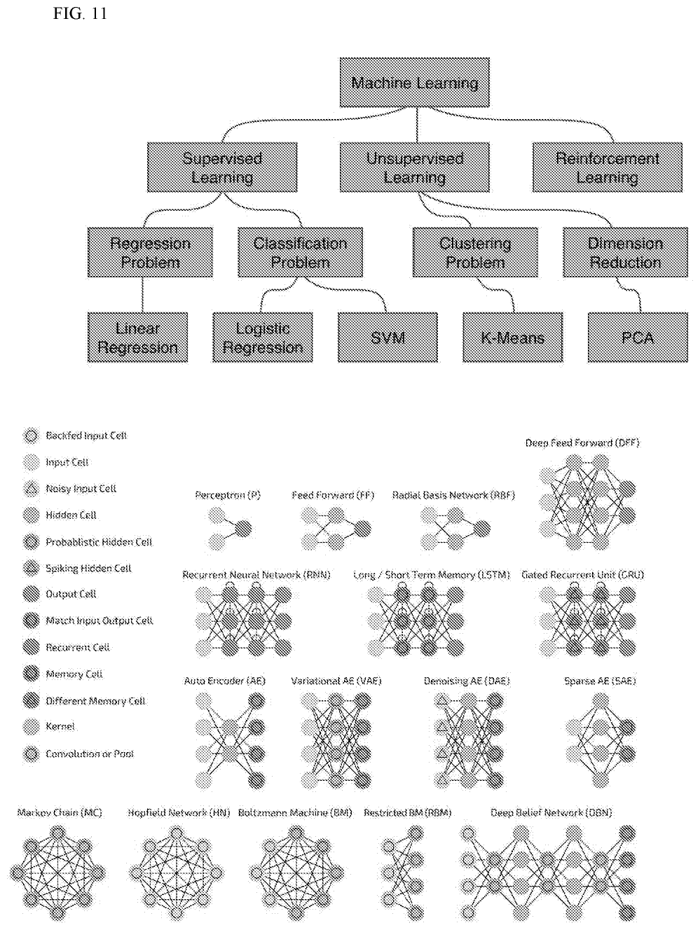

FIG. 11 shows in more details various exemplary learning machines to identify communities of the microbiome. While the learning machine optimizes all resources, details on the antenna are discussed next, with the expectation that other resource allocations. A striking feature about neural networks is their enormous size. To reduce size of the neural networks for edge learning while maintaining accuracy, the local neural network performs late down-sampling and filter count reduction, to get high performance at a low parameter count. Layers can be removed or added to optimize the parameter efficiency of the network. In certain embodiments, the system can prune neurons to save some space, and a 50% reduction in network size has been done while retaining 97% of the accuracy. Further, edge devices on the other hand can be designed to work on 8 bit values, or less. Reducing precision can significantly reduce the model size. For instance, reducing a 32 bit model to 8 bit model reduces model size. Since DRAM memory access is energy intensive and slow, one embodiment keeps a small set of register files (about 1 KB) to store local data that can be shared with 4 MACs as the leaning elements). Moreover, for video processing, frame image compression and sparsity in the graph and linear solver can be used to reduce the size of the local memory to avoid going to off chip DRAMs. For example, the linear solver can use a non-zero Hessian memory array with a Cholesky module as a linear solver.

In another embodiment, original full neural network can be trained in the cloud, and distillation is used for teaching smaller networks using a larger “teacher” network. Combined with transfer learning, this method can reduce model size without losing much accuracy. In one embodiment, the learning machine is supported by a GPU on a microprocessor, or to reconfigure the FPGA used as part of the baseband processing as neural network hardware.

The exemplary embodiments herein described, including what is described in the Abstract, are not intended to be exhaustive or to limit the scope of the invention to the precise forms disclosed. They are chosen and described to explain the principles of the invention and its application and practical use to allow others skilled in the art to comprehend its teachings.

As will be apparent to those skilled in the art in light of the foregoing disclosure, various equivalent alterations and modifications are possible in the practice of this invention without departing from the scope of the disclosure.

Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment. Further, the described features, structures, or characteristics of the present disclosure may be combined in any suitable manner in one or more embodiments. In this Detailed Description of the Invention, numerous specific details are provided for a thorough understanding of embodiments of the disclosure. One skilled in the relevant art will recognize, however, that the embodiments of the present disclosure can be practiced without one or more of the specific details, or with other methods, components, materials, and so forth. In other instances, well-known structures, materials, or operations are not shown or described in detail to avoid obscuring aspects of the present disclosure.

The scope of the present disclosure fully encompasses other embodiments and is to be limited, accordingly, by nothing other than the appended claims, wherein any reference to an element being made in the singular is intended to mean “one or more”, and is not intended to mean “one and only one” unless explicitly so stated. All structural and functional equivalents to the elements of the above-described preferred embodiment and additional embodiments are hereby expressly incorporated by reference and are intended to be encompassed by the present claims. Moreover, no requirement exists for an apparatus or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, are also encompassed by the present disclosure.

What is claimed is:

1. A coating method, comprising
selecting a microbial mixture with a predetermined microbial population characteristics for predetermined plant growth property;
using genetic testing to check on microbial population characteristics and iteratively growing the mixture with the predetermined microbial population characteristics as closed loop feedback;
combining the microbial mixture with a cross-linked hydrophilic mixture; and
coating a seed or fertilizer with the combined microbial mixture and cross-linked hydrophilic mixture.

2. The method of claim 1, comprising coating the seed as a carrier.

3. The method of claim 1, comprising embedding fungicides in the hydrophilic mixture to protect the seed.

4. The method of claim 1, comprising embedding the microbial mixture in a first time release component and embedding an active ingredient in a second time release component, further comprising releasing the microbial mixture at a different time from releasing the active ingredient.

5. The method of claim 1, comprising releasing microbes and active ingredient over non-overlapping periods.

6. The method of claim 1, comprising providing a first coating with an adhesive.

7. The method of claim 1, comprising providing a second coating with an outer shell.

8. The method of claim 7, comprising providing an adhesive with the shell.

9. The method of claim 1, wherein the microbial population is optimized for nitrogen.

10. The method of claim 1, comprising coating an organic fertilizer.

11. A method for making a coating material, comprising:
selecting a microbial mixture with a predetermined microbial population characteristics for predetermined plant growth property;
using genetic testing to verify the presence of the microbial population characteristics and iteratively growing the mixture with the predetermined microbial population characteristics in a feedback loop; and
combining the microbial mixture with a cross-linked hydrophilic mixture.

12. The method of claim 11, comprising embedding the microbial mixture in a first time release component and embedding an active ingredient in a second time release component, further comprising releasing the microbial mixture at a different time from releasing the active ingredient.

13. The method of claim 11, comprising releasing microbes and active ingredient over non-overlapping periods.

14. The method of claim 11, comprising coating a seed or fertilizer with the combined mixture.

15. A product, comprising:
a soil additive;
a microbial mixture with one or more predetermined microbial population characteristics for predetermined plant growth property and formed with genetic testing to verify the presence of the microbial population characteristics and iteratively growing the mixture with the predetermined microbial population characteristics in a feedback loop; and
a hydrogel covering the soil additive and the microbial mixture.

16. The product of claim 15, comprising a first adhesive to bind the microbial mixture.

17. The product of claim 15, comprising a second adhesive to bind a fertilizer or an active ingredient.

18. The product of claim 15, comprising a first controlled release material to release the microbial mixture during a first period, and a second controlled release material to release pesticide during a second period that does not overlap with the first period.

19. The product of claim 15, comprising a controlled release material to release the microbial mixture based on temperature, pH level, time, pressure, or humidity level.

20. The product of claim 15, wherein the soil additive comprises a seed or a fertilizer.
